(19) United States
(12) Patent Application Publication
(10) Pub. No.: US 2026/0365196 A1
(43) Pub. Date: Nov. 19, 2026

(54) AGENTIC ARTIFICIAL INTELLIGENCE PLATFORM FOR DISTRIBUTED ADAPTIVE VEHICLE CONTROL

(71) Applicant: AirWire Technologies, Reno, NV (US)

(72) Inventors: Debashis Bagchi, Reno, NV (US); Gerardo Gonzalez, Allen, TX (US)

(21) Appl. No.: 19/682,256

(22) Filed: May 19, 2026

Related U.S. Application Data
(60) Provisional application No. 63/808,162, filed on May 19, 2025.

(51) Int. Cl. B60W 50/14; B60R 25/22; B60R 25/24; B60W 10/04; B60W 10/18; B60W 10/20; B60W 30/06; B60W 30/09; B60W 30/12; B60W 50/00; G06F 21/31; G06F 40/205; G06F 40/40; G10L 13/027

(52) U.S. Cl. CPC B60W 50/14; B60R 25/22; B60R 25/24; B60W 10/04; B60W 10/18; B60W 10/20; B60W 30/06; B60W 30/09; B60W 30/12; B60W 50/0097; B60W 50/0098; G06F 21/31; G06F 40/205; G06F 40/40; G10L 13/027; B60W 2050/0022; B60W 2050/0028; B60W 2420/54; B60W 2540/21; B60W 2554/40; B60W 2555/20; B60W 2556/10; B60W 2556/35; B60W 2556/40; B60W 2556/45; B60W 2710/18; B60W 2710/20; B60W 2720/106

(57) ABSTRACT

Systems and methods are disclosed for vehicle-based artificial intelligence. In some examples, a system receives a prompt through an interactive interface, receives sensor data from a sensor of a vehicle, and receives environmental data from a data store. The system processes the sensor data and the environmental data to generate a fused environmental representation associated with the environment. The system processes the prompt and the fused environmental representation using a trained machine learning model to predict a hazard region and to generate a route for the vehicle based on the prompt and the hazard region. The system commands a vehicle controller of the vehicle to operate at least one actuator of the vehicle to affect operation of the vehicle along the route, and updates the trained machine learning model based on additional sensor data captured using the at least one sensor during the operation of the vehicle along the route.

### CROSS-REFERENCE TO RELATED APPLICATIONS

The present application claims the priority benefit of U.S. provisional application No. 63/808,162 filed May 19, 2025 and entitled “Vehicle-Based Artificial Intelligence Platform,” the disclosure of which is hereby incorporated by reference in its entirety.

### FIELD

This application is related to artificial intelligence. More specifically, this application relates to systems and methods for securely using an artificial intelligence algorithm, such as a trained machine learning model, with an interface for a vehicle.

### BACKGROUND

Artificial Intelligence (AI) systems are computer programs designed to make decisions in complex scenarios. In some cases, AI systems can include machine learning (ML) systems that learn by being trained using training data. AI systems can include ML models, rule-based AI systems, and/or heuristic-based AI systems. AI systems can be used across many industries, and can help with automating certain tasks.

Vehicles are complex systems with large numbers of moving parts that are subject to wear and tear, fluids that can need replacing, batteries that can run out of charge, and the like. It can be difficult to keep track of the status of vehicle components.

### SUMMARY

Systems and methods are disclosed for vehicle-based artificial intelligence. In some examples, a system receives a prompt through an interactive interface, receives sensor data from a sensor of a vehicle, and receives environmental data from a data store. The system processes the sensor data and the environmental data to generate a fused environmental representation associated with the environment. The system processes the prompt and the fused environmental representation using a trained machine learning model to predict a hazard region and to generate a route for the vehicle based on the prompt and the hazard region. The system commands a vehicle controller of the vehicle to operate at least one actuator of the vehicle to affect operation of the vehicle along the route, and updates the trained machine learning model based on additional sensor data captured using the at least one sensor during the operation of the vehicle along the route.

A method is described herein for vehicle-based artificial intelligence. The method includes receiving a prompt through an interactive interface, receiving sensor data from at least one sensor of a vehicle located in an environment, and receiving environmental data associated with the environment from at least one data store and through a network. The method includes processing the sensor data and the environmental data to generate a fused environmental representation associated with the environment. The method includes processing the prompt and the fused environmental representation using a trained machine learning model to predict a hazard region in the environment and to generate a route for the vehicle through the environment based on the prompt and the hazard region. The method includes commanding a vehicle controller of the vehicle to operate at least one actuator of the vehicle to affect operation of the vehicle along the route. The method include updating the trained machine learning model based on additional sensor data captured using the at least one sensor during the operation of the vehicle along the route.

A system is described herein for vehicle-based artificial intelligence. The system includes a memory that stores instructions and a processor coupled to the memory. Execution of the instructions by the processor causes the processor to perform operations. The operations include receiving a prompt through an interactive interface, receiving sensor data from at least one sensor of a vehicle located in an environment, and receiving environmental data associated with the environment from at least one data store and through a network. The operations include processing the sensor data and the environmental data to generate a fused environmental representation associated with the environment. The operations include processing the prompt and the fused environmental representation using a trained machine learning model to predict a hazard region in the environment and to generate a route for the vehicle through the environment based on the prompt and the hazard region. The operations include commanding a vehicle controller of the vehicle to operate at least one actuator of the vehicle to affect operation of the vehicle along the route. The method include updating the trained machine learning model based on additional sensor data captured using the at least one sensor during the operation of the vehicle along the route.

A non-transitory computer readable storage medium is described herein having embodied thereon a program. The program is executable by a processor to perform a method of vehicle-based artificial intelligence. The method includes receiving a prompt through an interactive interface, receiving sensor data from at least one sensor of a vehicle located in an environment, and receiving environmental data associated with the environment from at least one data store and through a network. The method includes processing the sensor data and the environmental data to generate a fused environmental representation associated with the environment. The method includes processing the prompt and the fused environmental representation using a trained machine learning model to predict a hazard region in the environment and to generate a route for the vehicle through the environment based on the prompt and the hazard region. The method includes commanding a vehicle controller of the vehicle to operate at least one actuator of the vehicle to affect operation of the vehicle along the route. The method include updating the trained machine learning model based on additional sensor data captured using the at least one sensor during the operation of the vehicle along the route.

### BRIEF DESCRIPTION OF THE DRAWINGS

The following figures are provided as examples of various techniques and architectures that can be used to implement the disclosed systems and methods.

FIG. 1 is a block diagram illustrating a vehicle artificial intelligence (AI) system that processes multimodal sensor data, environmental data, telemetry data, and user interaction data to generate vehicle operations, contextual responses, route modifications, hazard predictions, and machine-learning updates, in accordance with some examples.

FIG. 2 is a flow diagram illustrating a process for adaptive vehicle-based artificial intelligence, in accordance with some examples.

FIG. 3 is a conceptual diagram illustrating user interfaces associated with calendar events and calendar-management operations performed by the vehicle AI system, in accordance with some examples.

FIG. 4 is a conceptual diagram illustrating user interfaces associated with traveling to an event, navigation operations, route generation, environmental awareness, and vehicle-operation coordination performed by the vehicle AI system, in accordance with some examples.

FIG. 5 is a conceptual diagram illustrating user interfaces associated with shopping list management, and sharing operations performed by the vehicle AI system, in accordance with some examples.

FIG. 6 is a conceptual diagram illustrating user interfaces associated with vehicle status operations, vehicle location operations, navigation operations, and vehicle control operations performed by the vehicle AI system, in accordance with some examples.

FIG. 7 is a block diagram illustrating a distributed orchestration architecture associated with the vehicle AI system, in accordance with some examples.

FIG. 8 is a block diagram illustrating a process associated with environmental hazard orchestration and adaptive route generation performed by the vehicle AI system, in accordance with some examples.

FIG. 9 is a flow diagram illustrating a process associated with predictive destination coordination performed by the vehicle AI system, in accordance with some examples.

FIG. 10 is a block diagram illustrating an account-orchestration synchronization architecture associated with distributed vehicle-based artificial intelligence operations performed by the vehicle AI system, in accordance with some examples.

FIG. 11 is a perspective diagram illustrating a vehicle that includes various sensors and that can be used as part of a vehicle AI system, in accordance with some examples.

FIG. 12A is a perspective diagram illustrating a front surface of a mobile handset that includes front-facing cameras and that can be used as part of a vehicle AI system, in accordance with some examples.

FIG. 12B is a perspective diagram illustrating a rear surface of a mobile handset that includes rear-facing cameras and that can be used as part of a vehicle AI system, in accordance with some examples.

FIG. 13A is a perspective diagram illustrating an unmanned ground vehicle (UGV) that can be used as part of a vehicle AI system, in accordance with some examples.

FIG. 13B is a perspective diagram illustrating an unmanned aerial vehicle (UAV) that can be used as part of a vehicle AI system, in accordance with some examples.

FIG. 14 is a block diagram illustrating an example of a machine learning system for training, use of, and/or updating of one or more machine learning model(s) that are used to generate action(s) and/or response(s) in accordance with some examples.

FIG. 15 is a flow diagram illustrating a process for vehicle-based artificial intelligence, in accordance with some examples.

FIG. 16 is a diagram illustrating an example of a computing system for implementing certain components described herein.

### DETAILED DESCRIPTION

Artificial intelligence (AI) agent systems can process inputs, analyze context, and generate responses or actions based on learned patterns and external data. AI agent systems use algorithms, machine learning, and reasoning techniques to adapt to tasks, solve problems, and interact intelligently with users, vehicle, and/or environments.

Vehicle environments can present technical challenges for AI systems and other computing systems. Vehicle systems often involve continuously changing environmental conditions, dynamically changing sensor data, distributed computing resources, and latency-sensitive operations associated with navigation, safety, and vehicle coordination. In some cases, computing systems operating in vehicle environments may experience inefficiencies associated with synchronizing data across multiple systems, processing large amounts of sensor data in real time, adapting to changing operational conditions, or coordinating interactions between onboard systems and remote network systems.

In some cases, vehicle-based computing systems may experience technical limitations associated with integrating multimodal sensor data, coordinating distributed machine learning inference operations, synchronizing telemetry information across distributed systems, and generating low-latency vehicle-control operations responsive to dynamically changing environmental conditions.

Systems and methods for vehicle-based artificial intelligence are disclosed. In some examples, a system receives a prompt through an interactive user interface, receives sensor data from a sensor of a vehicle, and receives network data from a network data store. The system processes the prompt, the sensor data, and the network data using a trained machine learning model to generate a command and to generate a response that is conversationally responsive to the prompt. The system sends the command to a controller of the vehicle to cause the vehicle to perform an action. The system outputs the response through the user interface. The response is indicative of the action.

In some examples, the AI agent systems described herein can use ML model(s) that can be trained and/or updated over time to improve accuracy of the ML model(s) and/or of the AI agent systems themselves over time. In some examples, the AI agent systems described herein can take proactive measures to generate content, edit content, and/or otherwise manipulate files, for instance to improve operation of computers and/or other systems (e.g., where the content can include software code run on the computers).

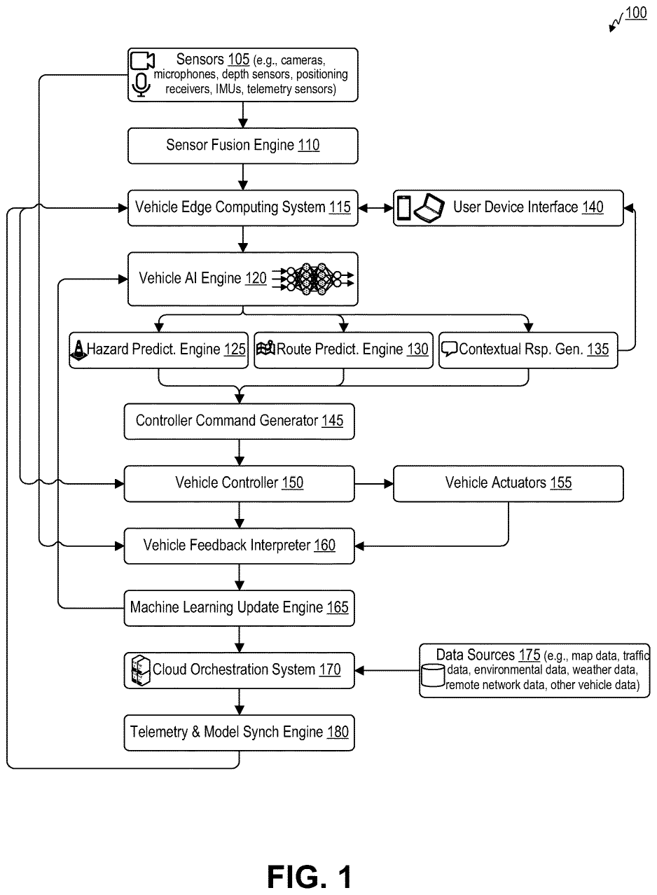

FIG. 1 is a block diagram illustrating a vehicle AI system 100 that processes multimodal sensor data, environmental data, telemetry data, and user interaction data to generate vehicle operations, contextual responses, route modifications, hazard predictions, and machine-learning updates. The vehicle AI system 100 can include one or more sensors 105, a sensor fusion engine 110, a vehicle edge computing system 115, a vehicle AI engine 120, a hazard prediction engine 125, a route prediction engine 130, a contextual response generator 135, a user device interface 140, a controller command generator 145, a vehicle controller 150, one or more vehicle actuators 155, a vehicle feedback interpreter 160, a machine learning update engine 165, a cloud orchestration system 170, one or more data sources 175, and a telemetry and model synchronization engine 180. In some examples, one or more portions of the vehicle AI system 100 are implemented using one or more computing systems such as the computing system 1600.

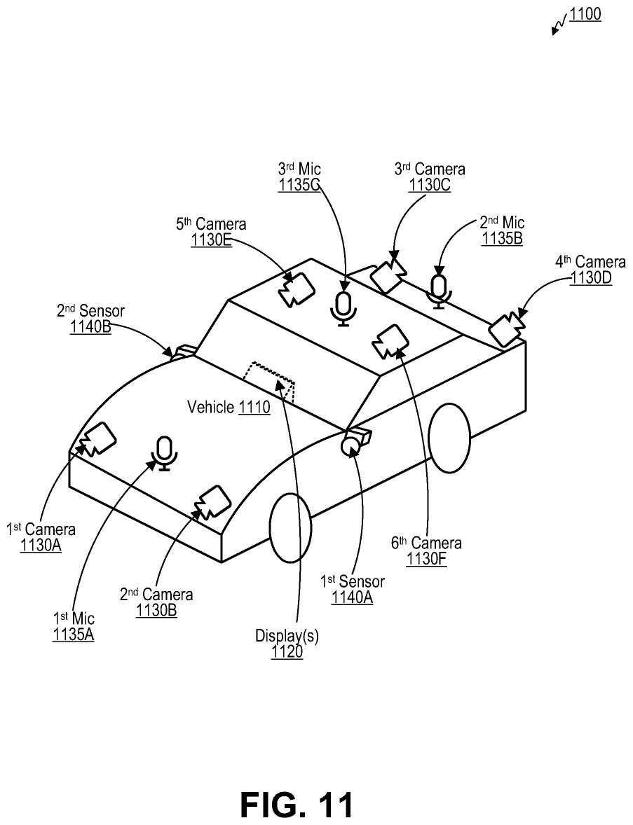

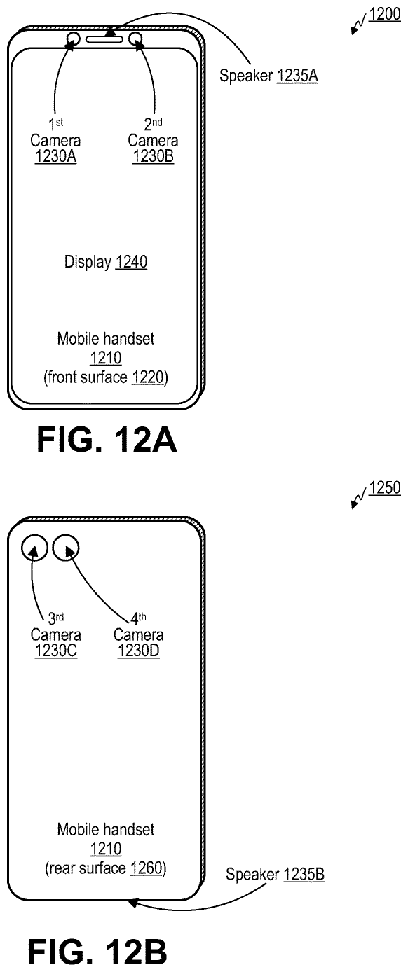

The sensors 105 can include one or more cameras, microphones, depth sensors, positioning receivers, inertial measurement units (IMUs), telemetry sensors, radar sensors, lidar sensors, ultrasonic sensors, thermal sensors, biometric sensors, wheel-speed sensors, tire pressure sensors, engine sensors, battery-state sensors, climate-control sensors, environmental sensors, accelerometers, gyroscopes, global navigation satellite system (GNSS) receivers, wireless ranging systems, and/or additional sensors associated with a vehicle. The sensors 105 can include the cameras and/or other sensors of vehicles and/or mobile devices such as those illustrated in FIGS. 11, 12A-12B, and/or 13A-13B. The sensors 105 can generate multimodal sensor data associated with an environment surrounding a vehicle, a physical state of the vehicle, movement of the vehicle, a user within the vehicle, and/or environmental conditions external to the vehicle. The sensors 105 can continuously generate streaming sensor data in real time or near-real time during operation of the vehicle. Sensor data generated by the sensors 105 can be transmitted asynchronously from the sensors 105 to the sensor fusion engine 110 and/or the vehicle edge computing system 115 using wired and/or wireless communication links.

The sensor fusion engine 110 processes sensor data received from the sensors 105 to generate a unified environmental representation associated with the environment surrounding the vehicle. In some examples, the sensor fusion engine 110 temporally aligns, spatially aligns, normalizes, filters, transforms, and/or combines data generated by different types of sensors 105. The sensor fusion engine 110 can perform simultaneous localization and mapping (SLAM), visual SLAM (VSLAM), occupancy-grid generation, object detection, object tracking, semantic segmentation, environmental classification, obstacle identification, lane detection, route-surface analysis, weather-state analysis, and/or trajectory prediction. The sensor fusion engine 110 can generate fused sensor representations that improve environmental awareness, route prediction accuracy, hazard prediction accuracy, and/or actuator-control accuracy. The sensor fusion engine 110 can include a SLAM engine configured to generate one or more local maps and/or global maps associated with an environment surrounding the vehicle. The SLAM engine can determine a pose of the vehicle within the environment and updates the local maps and/or global maps as new sensor data is received from the sensors 105.

The vehicle edge computing system 115 receives fused sensor data from the sensor fusion engine 110 and performs local processing operations associated with vehicle operation. In some examples, the vehicle edge computing system 115 includes one or more processors, graphics processing units (GPUs), tensor processing units (TPUs), neural processing units (NPUs), memory devices, edge inference accelerators, caches, communication interfaces, and/or local storage systems. The vehicle edge computing system 115 can perform low-latency inference operations locally within the vehicle to reduce communication latency and reduce dependence on remote cloud resources. The vehicle edge computing system 115 can perform asynchronous processing of sensor streams, telemetry streams, and/or user interaction streams. The vehicle edge computing system 115 can process different portions of incoming sensor data in parallel using distributed inference operations across multiple local processing resources. The vehicle edge computing system 115 can dynamically select between local inference, remote inference, and hybrid inference based on network conditions, computational load, confidence scores, timing constraints, and/or power-consumption constraints.

The vehicle AI engine 120 processes data associated with the vehicle, the environment surrounding the vehicle, one or more users, and/or remote network systems to generate predictions, commands, responses, and/or actions. In some examples, the vehicle AI engine 120 includes one or more trained machine learning (ML) models such as neural networks (NNs), transformer-based models, recurrent NNs (RNNs), convolutional NNs (CNNs), multimodal ML models, reinforcement learning models, generative models, probabilistic models, ensembles of ML models, rules-based AI algorithms, heuristics-based AI algorithms, and/or combinations thereof. The vehicle AI engine 120 can perform distributed inference operations using both the vehicle edge computing system 115 and the cloud orchestration system 170. The vehicle AI engine 120 can process sensor data, environmental data, telemetry data, route data, user interaction data, contextual data, and/or historical vehicle data in parallel using multiple machine learning models that specialize in different tasks. The vehicle AI engine 120 can dynamically route different data types to different ML models based on task type, latency requirements, confidence thresholds, and/or available computational resources.

The hazard prediction engine 125 processes fused sensor data, telemetry data, environmental data, and/or route data to identify current and/or predicted hazards associated with operation of the vehicle. In some examples, the hazard prediction engine 125 predicts weather-related hazards, road-surface hazards, traffic hazards, construction hazards, collision risks, visibility hazards, low-traction conditions, flooding conditions, debris conditions, unsafe route regions, and/or dynamic obstacle trajectories. In some examples, the hazard prediction engine 125 generates one or more hazard regions corresponding to portions of a route associated with elevated operational risk. In some examples, the hazard prediction engine 125 continuously updates predicted hazard regions based on incoming sensor data and environmental updates received asynchronously from the cloud orchestration system 170 and/or the data sources 175.

The route prediction engine 130 generates, modifies, updates, and/or optimizes routes associated with operation of the vehicle. In some examples, the route prediction engine 130 processes location data, map data, telemetry data, hazard data, traffic data, environmental data, destination data, historical route data, and/or user preference data to generate route predictions and/or route modifications. The route prediction engine 130 can dynamically reroute the vehicle around predicted hazards identified by the hazard prediction engine 125. The route prediction engine 130 can predict estimated arrival times, traffic congestion, charging availability, fuel availability, parking availability, and/or destination occupancy conditions. In some examples, the route prediction engine 130 uses reinforcement learning techniques to improve future route generation operations based on prior route outcomes and/or prior hazard-avoidance outcomes.

The contextual response generator 135 generates contextual responses associated with operation of the vehicle AI system 100. In some examples, the contextual response generator 135 generates audio responses, text responses, graphical responses, notifications, warnings, route summaries, environmental summaries, hazard notifications, maintenance notifications, predictive maintenance information, and/or confirmations associated with vehicle operations. The contextual response generator 135 can generate conversational responses that describe operations performed by the vehicle AI engine 120, the route prediction engine 130, and/or the hazard prediction engine 125. The contextual response generator 135 can generate responses synchronized with physical vehicle operations and/or synchronized with updates to route states or environmental conditions.

The user device interface 140 can include one or more mobile devices, vehicle displays, touchscreen displays, audio interfaces, microphones, speakers, wearable devices, augmented reality systems, heads-up displays, and/or remote user interfaces. In some examples, the user device interface 140 receives prompts, requests, commands, queries, and/or configuration information from one or more users. The user device interface 140 can output contextual responses generated by the contextual response generator 135. The user device interface 140 supports asynchronous user interactions during operation of the vehicle. The user device interface 140 can be synchronized with the vehicle edge computing system 115 and/or the cloud orchestration system 170 using low-latency communication channels. In some examples, inputs received through the user device interface 140 can be processed using the vehicle edge computing system 115, the vehicle AI engine 120, and/or the cloud orchestration system 170.

The vehicle AI engine 120 can process the inputs, in some cases along with data from one or more data sources 175 and/or the vehicle (e.g., sensor data from the sensors 105 of the vehicle), and a controller command generator 145 can generate a command for the vehicle controller 150 and/or vehicle actuators 155 of the vehicle. The controller command generator 145 generates commands associated with operation of the vehicle. The controller command generator 145 can convert outputs generated by the vehicle AI engine 120, the hazard prediction engine 125, and/or the route prediction engine 130 into controller-specific commands executable by the vehicle controller 150. The controller command generator 145 can generate steering commands, braking commands, acceleration commands, lane-modification commands, route-modification commands, climate-control commands, actuator-control commands, and/or access-control commands. The controller command generator 145 can send the command to the vehicle controller 150, causing the vehicle controller 150 and/or vehicle actuators 155 to perform an action.

The action can include routing the vehicle to a destination, starting the vehicle, scheduling the starting of the vehicle, scheduling a start of another action (e.g., by the vehicle or associated with the vehicle), providing access to the vehicle (e.g., temporarily or permanently) from one user to another, accelerating, braking (e.g., slowing and/or decelerating), turning, changing lanes, providing a status of component(s) of the vehicle, changing a status of component(s) of the vehicle, activating the vehicle actuators 155, deactivating the vehicle actuators 155, and/or reroute around hazards (e.g., weather hazards, construction, accidents, and/or other road hazards).

The vehicle controller 150 receives commands generated by the controller command generator 145 and controls operation of the vehicle based on the commands. In some examples, the vehicle controller 150 includes one or more electronic control units (ECUs), autonomous-driving controllers, advanced driver-assistance systems (ADAS), route-management systems, drivetrain controllers, steering controllers, braking controllers, climate-control systems, and/or power-management systems. The vehicle controller 150 can perform timing-sensitive operations associated with low-latency vehicle control.

The vehicle actuators 155 perform physical operations associated with the vehicle. The vehicle actuators 155 can include steering actuators, braking actuators, acceleration actuators, propulsion systems, drivetrain systems, climate-control actuators, robotic actuators, autonomous navigation systems, and/or movement actuators associated with unmanned vehicles. In some examples, the vehicle actuators 155 modify physical operation of the vehicle according to commands received from the vehicle controller 150.

The vehicle feedback interpreter 160 receives feedback associated with operation of the vehicle and interprets the feedback for use by the machine learning update engine 165. In some examples, the vehicle feedback interpreter 160 processes telemetry feedback, route completion data, hazard-avoidance results, actuator-state information, sensor feedback, user feedback, environmental outcome data, and/or operational deviations between predicted vehicle behavior and observed vehicle behavior. In some examples, the vehicle feedback interpreter 160 identifies successful operations, unsuccessful operations, prediction errors, route inefficiencies, and/or environmental mismatches.

The machine learning update engine 165 updates one or more machine learning models associated with the vehicle AI engine 120. In some examples, the machine learning update engine 165 performs retraining, fine-tuning, reinforcement learning, online learning, continual learning, weight adjustment, hyperparameter adjustment, checkpoint evaluation, and/or model synchronization operations. In some examples, the machine learning update engine 165 strengthens numeric weights associated with successful vehicle operations and weakens numeric weights associated with unsuccessful vehicle operations. The machine learning update engine 165 can implement reinforcement learning feedback loops using rewards associated with successful hazard avoidance, successful route completion, reduced latency, reduced actuator error, reduced fuel consumption, improved safety outcomes, and/or improved environmental prediction accuracy.

The cloud orchestration system 170 coordinates distributed operations associated with the vehicle AI system 100. In some examples, the cloud orchestration system 170 includes distributed orchestration engines, distributed inference systems, model management systems, telemetry aggregation systems, synchronization systems, authentication systems, route coordination systems, and/or environmental prediction systems. The cloud orchestration system 170 can perform asynchronous orchestration of requests generated by multiple vehicles and/or user devices. The cloud orchestration system 170 can perform parallel inference operations across multiple machine learning models. The cloud orchestration system 170 can dynamically allocate workloads among distributed computing resources to reduce latency and improve throughput.

The data sources 175 can include map data, traffic data, environmental data, weather data, remote network data, telemetry data associated with other vehicles, infrastructure data, charging-station data, parking-system data, hazard databases, and/or remote sensor systems. In some examples, the cloud orchestration system 170 retrieves data asynchronously from the data sources 175 and synchronizes the retrieved data with the vehicle edge computing system 115. In some examples, the data sources 175 include dynamically updated environmental prediction data generated by one or more environmental prediction subsystems associated with the cloud orchestration system 170.

In some examples, the vehicle AI engine 120 uses retrieval augmented generation (RAG) to augment or enhance the inputs received through the user device interface 140 (e.g., the requests, queries, and/or prompts) using data from the data sources 175. In some examples, the data sources 175 include databases, spreadsheets, tables, heaps, and/or other data structures. In some examples, the data sources 174 are servers with access to data storage that stores the data structures. In some examples, the data sources 175 are the data structures themselves. The vehicle AI engine 120, and/or related components (e.g., the hazard prediction engine 125, the route prediction engine 130, the contextual response generator 135, the controller command generator 145, the machine learning update engine 165), can be referred to herein as J.AI or JAI.

The telemetry and model synchronization engine 180 synchronizes telemetry data, model parameters, route states, environmental states, hazard states, and/or machine learning model checkpoints between the vehicle edge computing system 115 and the cloud orchestration system 170. In some examples, the telemetry and model synchronization engine 180 performs asynchronous synchronization operations using event streams, message queues, publish-subscribe systems, distributed state synchronization systems, and/or streaming telemetry systems. In some examples, the telemetry and model synchronization engine 180 synchronizes updates generated by the machine learning update engine 165 across multiple vehicles and/or multiple distributed machine learning systems. In some examples, the telemetry and model synchronization engine 180 synchronizes model updates using timing windows and/or consistency constraints to reduce synchronization conflicts and improve distributed inference consistency.

In some examples, the vehicle AI system 100 performs asynchronous data flow operations in which sensor data, telemetry data, route data, environmental data, and/or user interaction data are processed concurrently across multiple subsystems. In some examples, parallel machine learning inference operations are performed simultaneously by the vehicle AI engine 120, the hazard prediction engine 125, and the route prediction engine 130 to reduce latency associated with route generation and hazard avoidance. In some examples, synchronization loops continuously synchronize telemetry information, environmental updates, route states, model checkpoints, and/or hazard predictions between the vehicle edge computing system 115 and the cloud orchestration system 170. In some examples, feedback retraining loops continuously update machine learning models based on observed vehicle outcomes, environmental outcomes, actuator responses, route outcomes, and/or user feedback to improve operation of the vehicle AI system 100 over time.

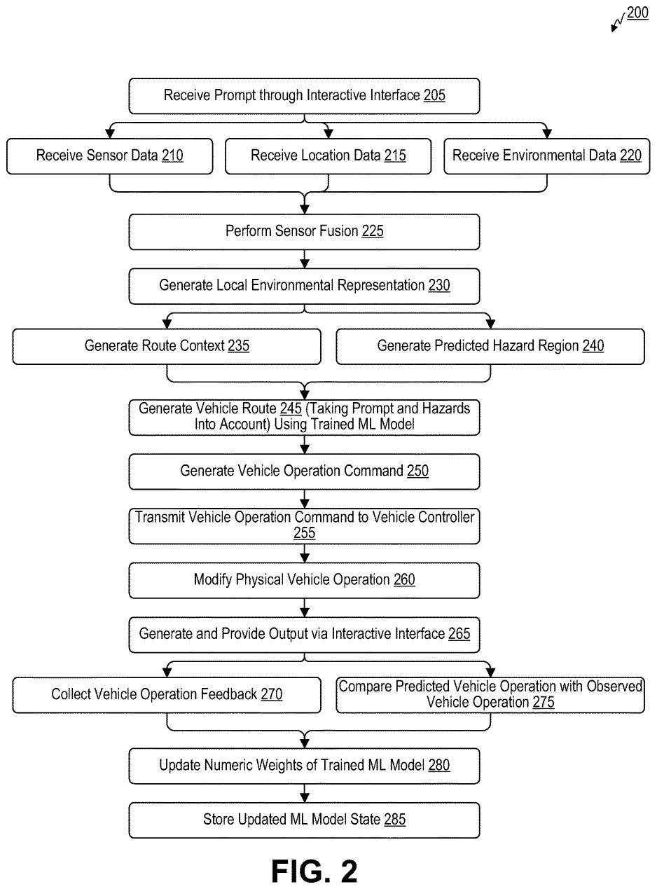

FIG. 2 is a flow diagram illustrating a process 200 for adaptive vehicle-based artificial intelligence. The process 200 is performed using a vehicle AI system, which can include the vehicle AI system 100, the sensors 105, the sensor fusion engine 110, the vehicle edge computing system 115, the vehicle AI engine 120, the hazard prediction engine 125, the route prediction engine 130, the contextual response generator 135, the user device interface 140, the controller command generator 145, the vehicle controller 150, the vehicle actuators 155, the vehicle feedback interpreter 160, the machine learning update engine 165, the cloud orchestration system 170, the telemetry and model synchronization engine 180, the vehicle 1110, the mobile handset 1210, the unmanned ground vehicle (UGV 1310), the unmanned aerial vehicle (UAV 1320), the AI system 1400, the ML engine 1420, the ML model(s) 1425, the computing system 1600, a system, an apparatus, a vehicle, a processor that performs instructions stored in a non-transitory computer-readable storage medium, any subsystems or components thereof, any other computing systems discussed herein, or a combination thereof. In some examples, portions of the process 200 are performed locally (e.g., at the vehicle edge computing system 1150), portions are performed remotely (e.g., using the cloud orchestration system 170), or a combination thereof. In some examples, operations of the process 200 are performed asynchronously, sequentially, in parallel, or in a combination thereof.

At operation 205, the vehicle AI system receives a prompt through an interactive interface (e.g., user device interface 140). In some examples, the prompt is received through the user device interface 140. In some examples, the prompt includes a spoken request, a typed request, a touchscreen interaction, a gesture input, a route request, a destination request, a vehicle-operation request, a climate-control request, a navigation request, a hazard-avoidance request, a parking request, a charging request, a maintenance request, or combinations thereof. In some examples, the prompt includes a request such as “take me to my next event,” “avoid heavy rain,” “increase cabin temperature,” “find a charging station,” “navigate around traffic,” or “take the fastest route.” In some examples, the prompt identifies a desired destination, a desired vehicle behavior, a preferred driving style, a desired environmental condition within the vehicle cabin, or combinations thereof. In some examples, the prompt is processed locally at the vehicle edge computing system 115 and/or remotely using the cloud orchestration system 170.

At operation 210, the vehicle AI system receives sensor data from one or more sensors (e.g., sensors 105) of a vehicle, a user device (e.g., mobile phone or handset), accessories coupled to either or both, or a combination thereof. The sensor data can include image data, audio data, telemetry data, inertial measurement data, radar data, lidar data, location-related sensor data, depth data, wheel-speed data, tire-pressure data, battery-state data, environmental data, occupancy data, and/or other sensor data associated with a vehicle. In some examples, the sensor data is received continuously as one or more streaming sensor-data feeds. In some examples, portions of the sensor data are received asynchronously and/or in parallel from multiple different sensors 105.

At operation 215, the vehicle AI system receives location data. In some examples, the location data is received from GNSS receivers, positioning systems, inertial measurement systems, SLAM systems, wireless ranging systems, map-localization systems, or combinations thereof. In some examples, the location data identifies a current position, orientation, heading, velocity, acceleration, route position, and/or predicted future position of the vehicle. In some examples, operation 215 is performed at least partially in parallel with operation 210. For instance, while sensor data is received from cameras and radar sensors at operation 210, location data can simultaneously be received from GNSS systems and/or SLAM systems at operation 215.

At operation 220, the vehicle AI system receives environmental data (e.g., from a network data store such as the data sources 175). In some examples, the environmental data is received from the cloud orchestration system 170, the data sources 175, remote network systems, weather systems, traffic systems, hazard databases, map systems, infrastructure systems, telemetry systems associated with other vehicles, or combinations thereof. In some examples, the environmental data includes weather data, traffic data, road-condition data, construction data, flooding data, hazard data, parking data, charging-station data, fuel-availability data, destination data, and/or infrastructure data. In some examples, operation 220 is performed at least partially in parallel with operations 210 and/or 215. In some examples, operations 210, 215, and 220 are performed asynchronously using separate communication channels, separate processing threads, and/or distributed processing resources associated with the vehicle edge computing system 115 and/or the cloud orchestration system 170.

At operation 225, the vehicle AI system performs sensor fusion. In some examples, the sensor fusion engine 110 processes the sensor data received at operation 210, the location data received at operation 215, the environmental data received at operation 220, and/or information associated with the prompt received at operation 205 to generate a fused environmental representation associated with an environment surrounding the vehicle. In some examples, operation 225 includes temporal alignment, spatial alignment, normalization, filtering, transformation, object detection, object tracking, occupancy-grid generation, semantic segmentation, SLAM processing, environmental classification, trajectory prediction, or combinations thereof. In some examples, operation 225 generates fused multimodal feature representations associated with the environment surrounding the vehicle and/or operational context associated with the prompt.

At operation 230, the vehicle AI system generates a local environmental representation. In some examples, the local environmental representation includes a local map, occupancy representation, semantic environmental model, hazard representation, object representation, environmental-condition representation, route representation, and/or vehicle-state representation. In some examples, the local environmental representation is generated using the sensor fusion engine 110, the vehicle AI engine 120, and/or one or more trained machine learning models. In some examples, the local environmental representation is continuously updated as additional sensor data, telemetry data, and/or environmental data are received.

At operation 235, the vehicle AI system generates route context. In some examples, the route context includes current route information, destination information, estimated arrival information, route-state information, lane information, traffic information, environmental-condition information, route-history information, user preference information, and/or driving-style information associated with the prompt received at operation 205, the sensor data received at operation 210, the location received at operation 215, and/or the environmental data received at operation 220. In some examples, the route prediction engine 130 generates the route context using the local environmental representation generated at operation 230 and/or contextual information associated with the prompt. In some examples, operation 235 includes parsing the prompt, sensor data, location, and/or environmental data (e.g., using a trained ML model), and the route context reflects context extracted from the prompt sensor data, location, and/or environmental data, such a requested destination, a preferred driving style, a preference for efficiency or speed, a request to avoid hazards, and/or user-specific route preferences.

At operation 240, the vehicle AI system generates a predicted hazard region. In some examples, the hazard prediction engine 125 processes the local environmental representation generated at operation 230 to identify one or more predicted hazard regions associated with operation of the vehicle. In some examples, the predicted hazard region corresponds to weather hazards, traffic hazards, construction hazards, collision risks, flooding conditions, obstacle regions, debris regions, low-traction regions, visibility hazards, unsafe route regions, or combinations thereof. In some examples, operation 240 is performed at least partially in parallel with operation 235. For instance, while the route prediction engine 130 generates route context at operation 235, the hazard prediction engine 125 can simultaneously process environmental data and telemetry data to generate the predicted hazard region at operation 240.

At operation 245, the vehicle AI system generates a vehicle route using a trained machine learning model. In some examples, the route prediction engine 130 generates or modifies a vehicle route based on the route context generated at operation 235, the predicted hazard region generated at operation 240, and/or the prompt received at operation 205. In some examples, operation 245 includes rerouting the vehicle around predicted hazard regions identified at operation 240. In some examples, operation 245 includes selecting a route based on a requested destination, estimated arrival time, charging availability, traffic conditions, weather conditions, passenger preferences, and/or driving-style preferences identified from the prompt. In some examples, operation 245 is performed using one or more trained ML models associated with the vehicle AI engine 120.

In some examples, the vehicle AI system continuously receives additional information (e.g., additional prompts, sensor data, location data, and/or environmental data) while the vehicle travels along the route. In some examples, the vehicle AI system dynamically modifies route-generation operations, hazard predictions, hazard-avoidance operations, vehicle operation commands, and/or contextual responses responsive to the additional information received during operation of the vehicle, and/or based on intermediate data generated based on additional information (e.g., updates to predicted hazard regions, vehicle operation commands, and/or responses).

At operation 250, the vehicle AI system generates a vehicle operation command. In some examples, the controller command generator 145 generates one or more vehicle operation commands based on the vehicle route generated at operation 245 and/or the prompt received at operation 205. In some examples, the vehicle operation command includes steering commands, braking commands, acceleration commands, lane-modification commands, navigation commands, route-modification commands, climate-control commands, seat-adjustment commands, lighting commands, audio-system commands, suspension commands, and/or actuator-control commands. In some examples, the vehicle operation command reflects a requested driving style, such as an efficiency-focused driving style, a comfort-focused driving style, a performance-focused driving style, or a hazard-avoidance driving style.

At operation 255, the vehicle AI system transmits the command to a controller (e.g., vehicle controllers 150, vehicle actuators 155) of the vehicle to cause the vehicle to perform an action. In some examples, the vehicle controller 150 includes one or more electronic control units (ECUs), advanced driver-assistance systems (ADAS), drivetrain controllers, steering controllers, braking controllers, autonomous-driving controllers, climate-control systems, and/or actuator-control systems.

At operation 260, the vehicle AI system modifies physical vehicle operation (e.g., while the vehicle navigates the route). In some examples, the vehicle controller 150 and/or the vehicle actuators 155 modify operation of the vehicle according to the vehicle operation command transmitted at operation 255. Operation 260 can include modifying steering behavior, braking behavior, acceleration behavior, navigation behavior, route progression, climate-control behavior, cabin temperature, seat position, suspension behavior, lane position, actuator states, and/or other operational characteristics of the vehicle.

At operation 265, the vehicle AI system generates and provides output via (e.g., of a response or other custom content) through the interactive interface (e.g., of operation 205). In some examples, the contextual response generator 135 generates one or more outputs associated with operation of the vehicle. In some examples, the outputs are provided through the user device interface 140. In some examples, the outputs include spoken responses, text responses, graphical responses, route summaries, navigation information, weather information, hazard notifications, maintenance notifications, climate-control confirmations, vehicle-status information, route-change notifications, and/or confirmations associated with physical vehicle operations performed at operation 260. In some examples, the outputs are indicative of (e.g., describing) the action(s) performed by the vehicle (e.g., at operation 260) based on the command (e.g.. generated in operation 250 and transmitted in operation 255) and/or indicative of (e.g., describing) action(s) taken by the other components of the vehicle AI system (e.g., in response to the prompt received at operation 205). In some examples, operation 265 is performed synchronously with operation 260 such that outputs provided through the user device interface 140 correspond to physical operations currently being performed by the vehicle.

At operation 270, the vehicle AI system collects vehicle operation feedback. In some examples, the vehicle feedback interpreter 160 receives telemetry feedback, actuator feedback, route-completion information, hazard-avoidance information, environmental-outcome information, operational-state information, and/or user feedback associated with operation of the vehicle. In some examples, the feedback is received through the interactive interface associated with operation 205 and/or operation 265. For instance, a user can provide confirmation feedback, correction feedback, preference feedback, satisfaction feedback, route feedback, driving-style feedback, and/or climate-control feedback through the user device interface 140. In some examples, operation 270 includes receiving updated sensor data from the sensors 105 after physical operation of the vehicle has been modified at operation 260.

At operation 275, the vehicle AI system compares predicted vehicle operation with observed vehicle operation. In some examples, the vehicle feedback interpreter 160 compares predicted vehicle behavior generated by the vehicle AI engine 120, the hazard prediction engine 125, and/or the route prediction engine 130 with observed vehicle behavior detected after operation 260. In some examples, operation 275 includes identifying prediction errors, route deviations, environmental mismatches, actuator inaccuracies, route inefficiencies, climate-control inaccuracies, driving-style mismatches, and/or hazard-avoidance outcomes. In some examples, operation 275 is performed at least partially in parallel with operation 270. For instance, while telemetry feedback and user feedback are collected at operation 270, the vehicle AI system can simultaneously compare predicted vehicle behavior with observed vehicle behavior at operation 275.

At operation 280, the vehicle AI system updates numeric weights of a trained machine learning model. In some examples, the machine learning update engine 165 updates one or more numeric weights, synaptic weights, parameters, hyperparameters, embeddings, checkpoints, and/or reinforcement-learning states associated with one or more trained machine learning models. In some examples, operation 280 includes reinforcement learning, online learning, continual learning, fine-tuning, retraining, checkpoint updating, gradient updating, backpropagation, or combinations thereof. In some examples, operation 280 strengthens weights associated with successful vehicle operations and weakens weights associated with unsuccessful vehicle operations. In some examples, operation 280 uses feedback associated with operations 270 and/or 275, including user feedback received through the interactive interface.

At operation 285, the vehicle AI system stores an updated machine learning model state. In some examples, the updated machine learning model state includes updates to, and/or updated variants of, model weights, checkpoints, embeddings, route-prediction parameters, hazard-prediction parameters, driving-style parameters, climate-control parameters, reinforcement-learning states, confidence values, and/or telemetry states. In some examples, operation 285 includes synchronizing the updated machine learning model state using the telemetry and model synchronization engine 180 and/or the cloud orchestration system 170. In some examples, the updated machine learning model state is stored locally using the vehicle edge computing system 115 and/or remotely using the cloud orchestration system 170.

In some examples, operations of the process 200 are repeated continuously during operation of the vehicle. In some examples, operations of the process 200 are performed asynchronously using distributed processing resources associated with the vehicle edge computing system 115 and the cloud orchestration system 170. In some examples, the process 200 includes synchronization loops in which telemetry data, environmental states, route states, hazard states, prompt context, user preferences, and/or machine learning model states are synchronized between local vehicle systems and remote cloud systems. In some examples, the process 200 includes feedback retraining loops in which machine learning models are continuously updated based on observed vehicle outcomes, route outcomes, environmental outcomes, actuator responses, and/or user feedback received through the interactive interface.

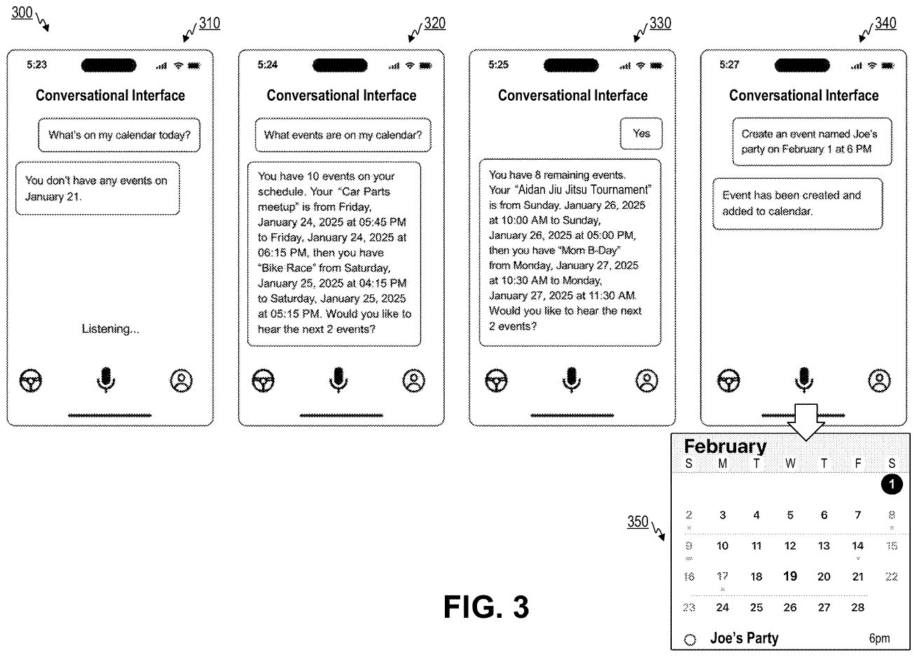

FIGS. 3-6 illustrate a number of user interfaces that represent examples of the user device interface 140, the interactive interface of operation 205 and operation 265, and/or another interface discussed herein. The user interfaces of FIGS. 3-6 can be displayed using a mobile device, a vehicle display, a touchscreen display, a wearable device, a heads-up display, a tablet device, a laptop device, or combinations thereof. In some examples, the user interfaces of FIGS. 3-6 support spoken interactions, touchscreen interactions, typed interactions, gesture interactions, and/or multimodal interactions associated with other applications, services, and/or systems.

FIG. 3 is a conceptual diagram 300 illustrating user interfaces 310-350 associated with calendar events and calendar-management operations performed by the vehicle AI system 100. The user interface 310 illustrates an example in which a user requests calendar information using the prompt “What's on my calendar today?” In some examples, the prompt is received through microphones associated with the sensors 105 and processed using the vehicle AI engine 120 and/or one or more trained machine learning models. In the illustrated example, the vehicle AI system 100 generates and outputs a contextual response indicating that no events are scheduled for the day.

The user interface 320 illustrates an example in which the vehicle AI system 100 retrieves and outputs information associated with multiple upcoming events responsive to the prompt “What events are on my calendar?” In some examples, the vehicle AI system 100 interfaces with one or more calendar applications, scheduling systems, cloud calendar services, email systems, and/or network-connected data stores to retrieve event information associated with the user. In some examples, the retrieved event information includes event names, event times, event locations, participant information, route information, weather information, traffic information, and/or estimated travel-duration information. In some examples, the vehicle AI system 100 prioritizes events based on time, location, estimated travel duration, and/or inferred user intent.

The user interface 330 illustrates an example in which the vehicle AI system 100 outputs additional upcoming-event information responsive to a prior interaction. In some examples, the vehicle AI system 100 dynamically determines which events are most relevant based on contextual information associated with the user, route information, environmental data, telemetry data, and/or current vehicle state. For instance, the user interface 330 identifies an “Aidan Jiu Jitsu Tournament” on Friday, January 24 from 5:45 PM to 6:15 PM, and a “Bike Race” on Saturday, January 25 from 4:15 pm to 5:15 PM.

The user interface 340 illustrates an example in which a user provides the request “Create an event named Joe's party on February 1 at 6 PM.” The vehicle AI system 100 can extract event information from the request using one or more trained machine learning models associated with the vehicle AI engine 120. In some examples, the vehicle AI system 100 interfaces with one or more calendar applications, scheduling systems, cloud calendar services, and/or enterprise collaboration systems to automatically create and store a calendar event associated with the request, as shown in a user interface 350 showing a calendar with a “Joe's Party” event created on February 1 at 6:00 PM. In some examples, the vehicle AI system 100 automatically generates calendar invites, notifications, synchronization objects, and/or reminder information associated with the newly created event. In some examples, the vehicle AI system 100 automatically transmits invitations and/or synchronization data to devices and/or calendar accounts associated with one or more invited users. The vehicle AI system 100 can associate the newly created event with vehicle operations, including route generation, estimated departure-time determination, charging coordination, parking coordination, and/or hazard-aware navigation operations.

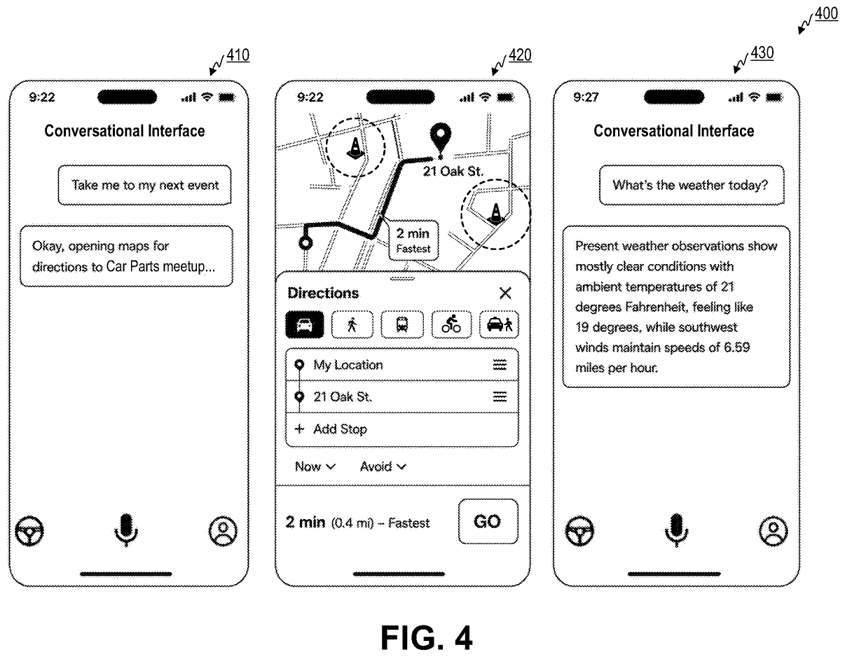

FIG. 4 is a conceptual diagram 400 illustrating user interfaces 410-430 associated with traveling to an event, navigation operations, route generation, environmental awareness, and vehicle-operation coordination performed by the vehicle AI system 100.

The user interface 410 illustrates an example in which a user provides the request “Take me to my next event.” In some examples, the vehicle AI system 100 identifies the next scheduled event using one or more calendar systems associated with the user and retrieves event information including destination information, event timing information, traffic information, environmental information, and/or route information. In the illustrated example, the vehicle AI system 100 outputs the response “Okay, opening maps for directions to Car Parts meetup . . . ”

The user interface 420 illustrates an example of a navigation interface associated with a route generated by the route prediction engine 130. In some examples, the route is generated based on sensor data from the sensors 105, telemetry data, environmental data from the data sources 175, traffic information, weather information, map information, and/or hazard information identified by the hazard prediction engine 125. In some examples, the route is dynamically updated in response to detected hazards, traffic conditions, environmental conditions, and/or updated telemetry information. For instance, the map in the user interface 420 includes two predicted hazard regions or areas, represented as circles with dashed outlines and traffic cone icons. The route illustrated in the user interface 420 avoids the two predicted hazard regions or areas, and can have been generated (e.g., by the vehicle AI system 100) to avoid these predicted hazards.

In some examples, the route displayed through the user interface 420 is a route along which the vehicle autonomously drives. For example, the controller command generator 145 can generate vehicle operation commands that are transmitted to the vehicle controller 150 to control steering, braking, acceleration, lane positioning, and/or navigation operations associated with the generated route. In some examples, the vehicle AI system 100 causes one or more vehicle actuators 155 to assist with driving operations using driver-assistance operations including steering assistance, braking assistance, adaptive cruise-control operations, obstacle-avoidance operations, and/or lane-centering operations. In some examples, the route is generated and updated using SLAM operations performed by the sensor fusion engine 110.

The user interface 430 illustrates an example in which the vehicle AI system 100 provides weather information responsive to the request “What's the weather today?” In some examples, the vehicle AI system 100 retrieves weather information from one or more weather systems and/or environmental data sources associated with the data sources 175. In some examples, the weather information corresponds to a current vehicle location, a destination location, and/or one or more route segments associated with the generated route. In some examples, the vehicle AI system 100 modifies route-generation operations, hazard-avoidance operations, braking operations, and/or navigation operations based on detected and/or predicted weather conditions.

In some examples, the vehicle AI system 100 synchronizes route information, environmental information, hazard information, and/or vehicle-operation information associated with the user interfaces 410-430 using the telemetry and model synchronization engine 180 and/or the cloud orchestration system 170. In some examples, route updates, environmental updates, telemetry updates, and/or hazard updates are processed asynchronously and/or in parallel using distributed processing resources associated with the vehicle edge computing system 115 and the cloud orchestration system 170.

In some examples, interactions associated with the user interfaces 410-430 are used as feedback for improving operation of one or more trained ML models associated with the vehicle AI engine 120, the route prediction engine 130, and/or the hazard prediction engine 125. For example, user responses, route selections, route deviations, driving outcomes, travel durations, hazard-avoidance outcomes, environmental outcomes, and/or user corrections associated with the displayed route can be processed using the machine learning update engine 165 to improve future route-generation operations, navigation operations, hazard-prediction operations, and/or vehicle-control operations.

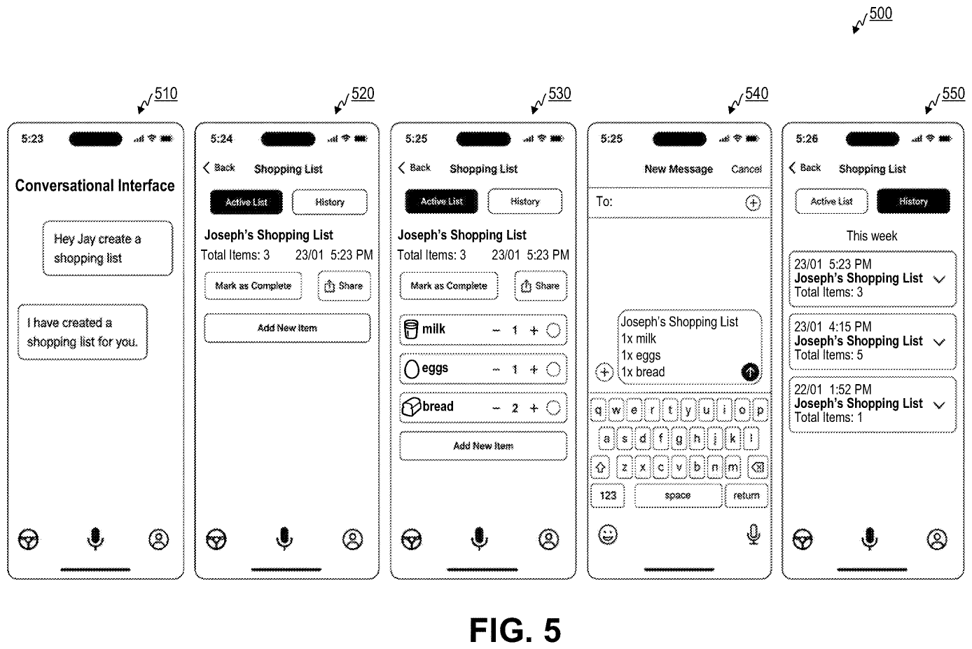

FIG. 5 is a conceptual diagram 500 illustrating user interfaces 510-550 associated with shopping list generation, management, and sharing operations performed by the vehicle AI system 100. In some examples, the user interfaces 510-550 are displayed using a mobile device, a vehicle display, a touchscreen display, a wearable device, a tablet device, a heads-up display, or combinations thereof. In some examples, the user interfaces 510-550 support spoken interactions, touchscreen interactions, typed interactions, gesture interactions, and/or multimodal interactions associated with shopping-list management.

The user interface 510 illustrates an example in which a user provides a request associated with generating a shopping list. In the illustrated example, the user provides the request “Hey Jay create a shopping list.” In some examples, the request is received as spoken audio through one or more microphones associated with the sensors 105 and/or the user device interface 140. The request can be processed (e.g., parsed, interpreted, analyzed) using the vehicle AI engine 120, one or more trained machine learning models associated with the AI system 1400, the cloud orchestration system 170, or combinations thereof. In the illustrated example, the vehicle AI system 100 generates and outputs the response “I have created a shopping list for you.” In some examples, the response is generated using the contextual response generator 135 and is output as displayed text, synthesized speech, graphical content, notifications, or combinations thereof.

The user interface 520 illustrates an example of a shopping-list management interface generated by the vehicle AI system 100. In some examples, the shopping-list management interface includes an active-list view and a history view associated with one or more shopping lists. In some examples, the vehicle AI system 100 automatically generates a shopping list object, list identifier, synchronization object, timestamp, and/or associated metadata responsive to the request received through the user interface 510. In some examples, the shopping list is stored locally using the vehicle edge computing system 115 and/or remotely using the cloud orchestration system 170 and one or more network-connected data stores.

The user interface 530 illustrates an example in which shopping-list items are added to the shopping list. In the illustrated example, the shopping list includes “milk,” “eggs,” and “bread.” In some examples, shopping-list items are added using spoken requests, typed input, touchscreen input, barcode scanning, image recognition, predictive suggestions, and/or combinations thereof. In some examples, the vehicle AI system 100 uses one or more trained machine learning models to predict shopping-list items based on user behavior, purchase history, calendar-event information, route information, location history, household information, and/or prior shopping-list information. In some examples, the shopping-list interface supports quantity adjustments, item-completion tracking, categorization, prioritization, and/or synchronization across multiple devices associated with one or more users.

The user interface 540 illustrates an example of a messaging-service interface through which a shopping list is exported and/or shared. In some examples, the vehicle AI system 100 interfaces with one or more messaging systems, text-messaging systems, email systems, collaboration systems, social-network systems, and/or communication services to transmit shopping-list information to one or more additional users. In some examples, the shopping list is transmitted as text content, structured data, a synchronization object, a shared document, a shared list object, a network link, or combinations thereof.

In some examples, the shopping list shared through the user interface 540 dynamically updates as the shopping list is modified through the shopping list interfaces (e.g., user interface 520, user interface 530, user interface 550). For example, when a shopping-list item is added, removed, modified, reprioritized, or marked complete through one device, the vehicle AI system 100 can synchronize updated shopping-list information across multiple user devices and/or messaging interfaces using the telemetry and model synchronization engine 180 and/or the cloud orchestration system 170. The shopping-list synchronization operations can be performed asynchronously and/or in near real time.

The user interface 550 illustrates an example in which multiple shopping lists are displayed. In some examples, the vehicle AI system 100 maintains multiple active shopping lists and/or historical shopping lists associated with different events, stores, categories, users, households, locations, routes, and/or schedules. The vehicle AI system 100 can prioritize and surface particular shopping lists based on contextual information associated with the vehicle, including route information, current location, destination information, calendar-event information, store proximity, and/or predicted user intent.

In some examples, shopping-list operations associated with the user interfaces 510-550 are integrated with vehicle operations performed by the vehicle AI system 100. For example, the vehicle AI system 100 can automatically generate navigation routes to stores associated with shopping-list items, identify nearby stores carrying particular items, modify routes based on store availability and traffic conditions, and/or generate reminders associated with shopping-list completion based on detected vehicle location and/or calendar-event timing.

In some examples, the vehicle AI system 100 parses shopping-list items associated with the user interfaces 510-550 and determines stores from which the user historically purchases particular items. In some examples, the vehicle AI system 100 interfaces with one or more network-connected inventory systems, retail systems, store databases, and/or online services to determine whether the stores currently have the shopping-list items in stock. In some examples, the route prediction engine 130 generates one or more routes to the stores and determines an order in which the stores are visited based on factors such as travel distance, travel time, traffic conditions, environmental conditions, perishability of items (e.g., to obtain quickly-perishable items like ice cream later than more stable items), storage conditions within the vehicle, and/or predicted shopping efficiency. In some examples, the vehicle AI system 100 autonomously navigates the vehicle to the stores and/or causes one or more vehicle actuators 155 to assist with navigation along the generated route.

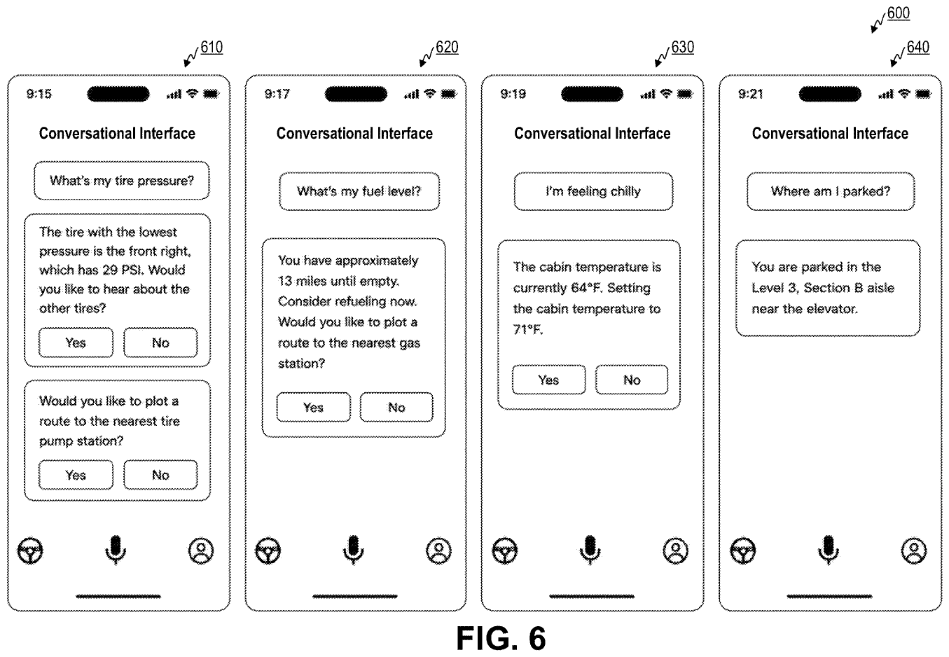

FIG. 6 is a conceptual diagram 600 illustrating user interfaces 610-640 associated with vehicle status operations, vehicle location operations, navigation operations, and vehicle control operations performed by the vehicle AI system 100. The user interfaces 610-640 are examples of the user device interface 140. In some examples, the user interfaces 610-640 are displayed using a mobile device, a vehicle infotainment display, a dashboard display, a touchscreen display, a wearable device, or combinations thereof. In some examples, the user interfaces 610-640 support spoken interactions, touchscreen interactions, typed interactions, and/or multimodal interactions associated with vehicle monitoring and vehicle control.

The user interface 610 illustrates an example in which a user requests tire-pressure information associated with the vehicle. In the illustrated example, the user provides the request “What's my tire pressure?” In response, the vehicle AI system 100 retrieves sensor data from one or more tire-pressure sensors associated with the sensors 105 and determines that the front-right tire has the lowest pressure. In some examples, the vehicle AI system 100 generates and outputs a response indicating the tire-pressure status and offering to identify a nearby tire pump station. In some examples, the route prediction engine 130 automatically generates a route to the tire pump station based on current vehicle location, traffic conditions, and/or environmental conditions. In some examples, the vehicle AI system 100 autonomously drives the vehicle along the generated route and/or causes one or more vehicle actuators 155 to assist a user with driving along the route.

In some examples, the vehicle AI system 100 compares current or predicted tire pressure values associated with the vehicle against one or more tire-pressure thresholds. Reaching or crossing such thresholds can cause the vehicle AI system 100 to proactively generate a notification, modify a route, reduce vehicle speed, modify suspension behavior, increase following distance, and/or generate a route to a service location.

The user interface 620 illustrates an example in which a user requests fuel-level information associated with the vehicle. In the illustrated example, the user provides the request “What's my fuel level?” In response, the vehicle AI system 100 retrieves telemetry data and/or fuel-level sensor data from the sensors 105 and determines a remaining driving range associated with the vehicle. In the illustrated example, the vehicle AI system 100 outputs a response indicating that the vehicle has approximately 13 miles remaining until empty and suggests routing to a nearby gas station. In some examples, the vehicle AI system 100 identifies nearby fueling stations using map data, location data, and/or network data from the data sources 175. In some examples, the vehicle AI system 100 automatically generates a route to a selected fueling station and autonomously navigates the vehicle to the fueling station and/or causes one or more vehicle actuators 155 to assist with navigation along the route.

In some examples, the vehicle AI system 100 compares current or predicted fuel levels, predicted remaining range values, battery-charge levels, and/or predicted remaining charge values against one or more corresponding thresholds. Reaching or crossing such thresholds can cause the vehicle AI system 100 to proactively generate notifications, modify a route, identify charging stations or fueling stations, generate a charging route or fueling route, modify vehicle speed, modify climate-control operations, reduce power consumption, and/or initiate energy-conservation operations.

The user interface 630 illustrates an example in which a user requests modification of an environmental condition within the vehicle. In the illustrated example, the user provides the request “I'm feeling chilly.” In response, the vehicle AI system 100 retrieves cabin-temperature information from one or more climate-control sensors associated with the sensors 105 and determines a current cabin temperature associated with the vehicle. The vehicle AI system 100 can generate climate-control command(s) using the controller command generator 145 and transmits the climate-control commands to the vehicle controller 150 to modify operation of one or more climate-control actuators associated with the vehicle. In the illustrated example, the vehicle AI system 100 outputs a response indicating that the cabin temperature is being increased from 64 °F to 71 °F.

The user interface 640 illustrates an example in which a user requests location information associated with the vehicle. In some examples, the vehicle AI system 100 remotely obtains the current location of the vehicle through communication between a mobile device associated with the user and the vehicle through one or more network systems and/or server systems associated with the cloud orchestration system 170. For example, the vehicle AI system 100 can communicate with the vehicle using one or more application programming interfaces (APIs), telematics systems, wireless communication systems, and/or vehicle-network services to retrieve current vehicle location information. In some examples, the vehicle AI system 100 determines the vehicle location based on a previously stored location associated with a prior parking operation, such as a location at which the user last exited and parked the vehicle. In some examples, the vehicle AI system 100 generates and outputs a map interface identifying the vehicle location and generates a walking route and/or a driving route to the vehicle location. In some examples, the vehicle AI system 100 can autonomously drive the vehicle toward the user's current location and/or autonomously reposition the vehicle based on the retrieved vehicle-location information.

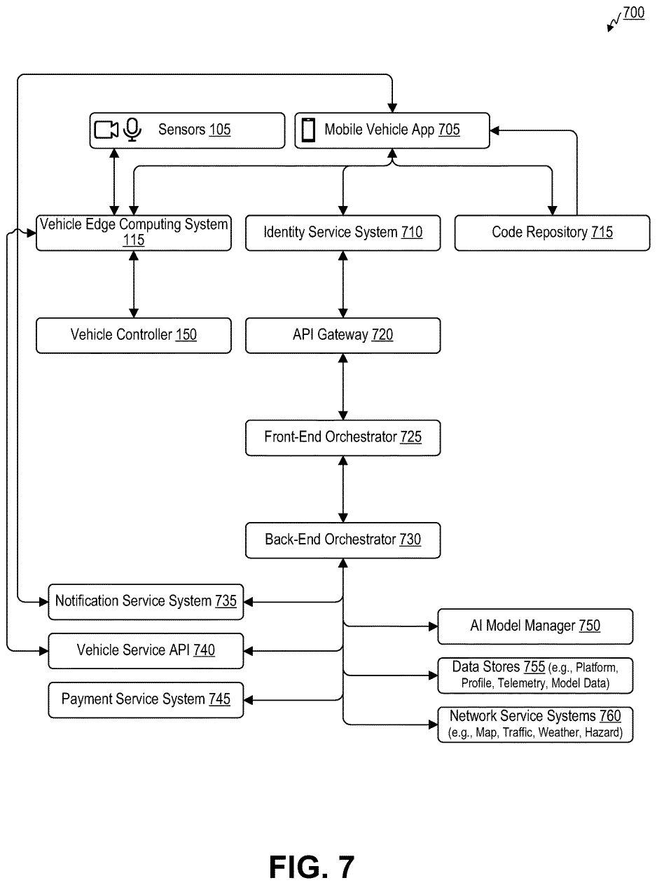

FIG. 7 is a block diagram illustrating a distributed orchestration architecture 700 associated with the vehicle AI system 100. In some examples, the distributed orchestration architecture 700 coordinates interactions among vehicle systems, mobile-device systems, cloud systems, authentication systems, machine learning systems, and external network services to support low-latency vehicle-based artificial intelligence operations. In some examples, the architecture 700 improves synchronization, scalability, distributed inference performance, telemetry coordination, and secure communication between distributed computing systems associated with a vehicle ecosystem.

The architecture 700 includes the sensors 105, the mobile vehicle app 705, the vehicle edge computing system 115, the identity service system 710, the code repository 715, the API gateway 720, the front-end orchestrator 725, the back-end orchestrator 730, the notification service system 735, the vehicle service API 740, the payment service system 745, the AI model manager 750, the data stores 755, and the network service systems 760.

The sensors 105 can generate sensor data associated with operation of a vehicle, including image data, audio data, telemetry data, environmental data, vehicle-state data, and/or location data. The sensor data can be transmitted to the vehicle edge computing system 115 for local processing operations. Local processing at the vehicle edge computing system 115 can reduce communication latency and improve responsiveness of navigation operations, hazard-detection operations, and/or vehicle-control operations.

In some examples, the mobile vehicle app 705 interfaces with the vehicle edge computing system 115 and/or cloud-based orchestration systems to receive prompts, provide contextual responses, synchronize user data, and/or coordinate vehicle operations. The mobile vehicle app 705 can support asynchronous synchronization with distributed systems, improving continuity between vehicle sessions and mobile-device sessions.

In some examples, the identity service system 710 performs authentication operations, authorization operations, token-generation operations, account-validation operations, and/or secure-session operations associated with the vehicle AI system 100. The identity service system 710 can reduce unauthorized access to vehicle systems and improve secure coordination between mobile devices, vehicles, and cloud systems.

In some examples, the API gateway 720 routes requests between mobile systems, vehicle systems, orchestration systems, AI systems, and/or external network systems. In some examples, the API gateway 720 performs request validation, traffic management, load balancing, protocol translation, and/or rate-limiting operations to improve reliability and scalability of distributed communications.

In some examples, the front-end orchestrator 725 coordinates user-facing operations associated with prompts, responses, notifications, routing requests, calendar operations, shopping-list operations, and/or reservation operations. In some examples, the back-end orchestrator 730 coordinates distributed processing operations associated with machine learning inference, telemetry synchronization, route generation, hazard prediction, environmental prediction, and/or external-service integration.

In some examples, the notification service system 735 generates and transmits notifications associated with vehicle status, route changes, hazards, calendar events, reservations, maintenance conditions, authentication events, and/or synchronization events. In some examples, asynchronous notification delivery improves responsiveness without blocking real-time vehicle-control operations.

In some examples, the vehicle service API 740 interfaces with vehicle systems including the vehicle controller 150, the vehicle actuators 155, the vehicle edge computing system 115, and/or telematics systems associated with the vehicle. In some examples, the vehicle service API 740 supports remote retrieval of vehicle telemetry data, remote vehicle-location determination, remote vehicle-command generation, climate-control operations, navigation operations, and/or autonomous vehicle operations.

In some examples, the payment service system 745 performs secure payment-processing operations associated with subscriptions, reservations, charging operations, parking operations, toll operations, retail purchases, and/or other transactions associated with the vehicle AI system 100. In some examples, isolating payment-processing operations within the payment service system 745 improves security and reduces exposure of sensitive payment information to other subsystems.

In some examples, the AI model manager 750 manages one or more trained machine learning models associated with speech processing, route prediction, hazard prediction, environmental prediction, generative AI operations, and/or contextual-response generation. In some examples, the AI model manager 750 dynamically selects among different machine learning models based on latency constraints, compute-resource availability, prediction confidence, and/or operational context. The AI model manager 750 can coordinate distributed inference operations between cloud systems and the vehicle edge computing system 115 to reduce latency and improve inference throughput.

In some examples, the data stores 755 store platform data, profile data, telemetry data, model data, route data, environmental data, vehicle-state data, and/or synchronization data associated with operation of the vehicle AI system 100. In some examples, the data stores 755 support asynchronous synchronization and distributed caching operations to reduce redundant network requests and improve response latency.

In some examples, the network service systems 760 include map systems, traffic systems, weather systems, hazard systems, parking systems, charging systems, inventory systems, and/or external network-connected services. In some examples, the back-end orchestrator 730 retrieves environmental information and/or route-related information from the network service systems 760 and synchronizes the information with the vehicle edge computing system 115 and/or the AI model manager 750.

In some examples, the architecture 700 supports asynchronous data flow operations in which telemetry data, route data, environmental data, prompt data, and/or model data are processed concurrently across multiple distributed subsystems. In some examples, the architecture 700 supports parallel machine learning inference operations using multiple specialized machine learning models managed by the AI model manager 750. In some examples, the architecture 700 supports synchronization loops that continuously synchronize telemetry information, route states, model states, authentication states, and/or environmental states among the mobile vehicle app 705, the vehicle edge computing system 115, the front-end orchestrator 725 and the back-end orchestrator 730, and the cloud-based systems associated with the architecture 700.

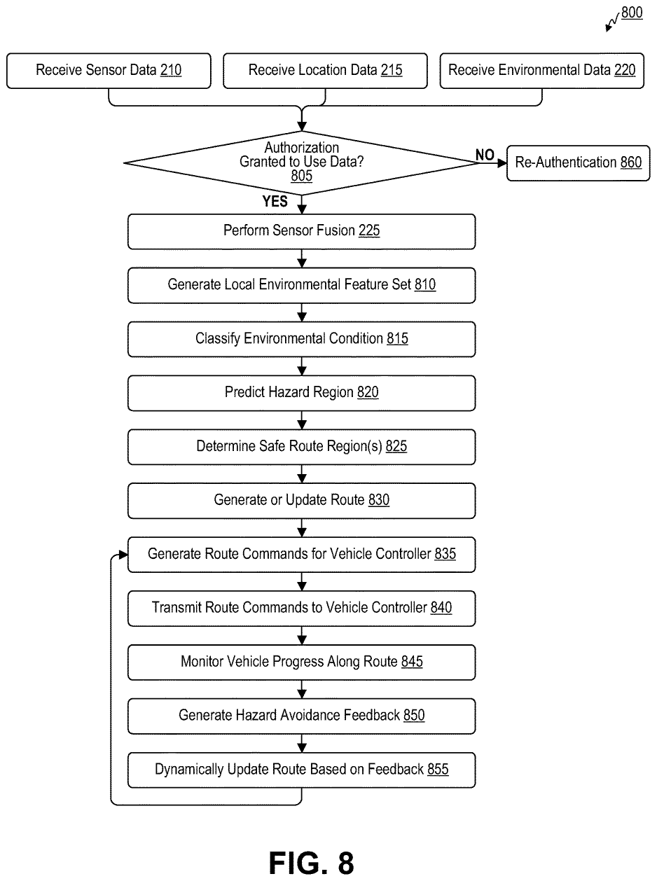

FIG. 8 is a block diagram illustrating a process 800 associated with environmental hazard orchestration and adaptive route generation performed by the vehicle AI system 100. In some examples, the process 800 is performed using the sensors 105, the sensor fusion engine 110, the vehicle edge computing system 115, the vehicle AI engine 120, the hazard prediction engine 125, the route prediction engine 130, the controller command generator 145, the vehicle controller 150, the vehicle actuators 155, the cloud orchestration system 170, the telemetry and model synchronization engine 180, one or more trained ML models associated with the machine learning system 4500, one or more computing systems such as the computing system 4600, or combinations thereof. In some examples, portions of the process 800 are performed locally at the vehicle edge computing system 115 while additional portions are performed remotely using the cloud orchestration system 170.

The process 800 includes operation 210, operation 215, operation 220, and/or operation 225 from the process 200. At operation 210, the vehicle AI system receives sensor data (e.g., from the vehicle's sensors and/or sensors of a mobile handset). At operation 215, the vehicle AI system receives location data (e.g., from the vehicle's systems and/or from a mobile handset). At operation 220, the vehicle AI system receives environmental data (e.g., from data sources 175 and/or data stores 755).

At operation 805, the vehicle AI system determines whether authorization is granted to use the received data. In some examples, the authorization determination includes validating user permissions, authentication tokens, account permissions, privacy settings, sensor permissions, location permissions, and/or access-control policies using the identity service system 710 and/or one or more authentication systems. In some examples, the authorization determination improves security and reduces unauthorized access to vehicle telemetry data, location data, and/or environmental data.

In response to determining that authorization is not granted, the process 800 proceeds to operation 860. At operation 860, the vehicle AI system performs re-authentication operations. In some examples, the re-authentication operations include biometric authentication operations, credential validation operations, token refresh operations, multi-factor authentication operations, mobile-device authentication operations, vehicle-authentication operations, and/or secure-session validation operations.

In response to determining that authorization is granted at operation 805, the process 800 proceeds to operation 225. At operation 225, the vehicle AI system performs sensor fusion. In some examples, the sensor fusion engine 110 processes the vehicle sensor data received at operation 210, the location data received at operation 215, and/or the environmental data received at operation 220 to generate fused environmental representations associated with the environment surrounding the vehicle. In some examples, operation 225 includes temporal alignment, spatial alignment, object detection, object tracking, occupancy-grid generation, semantic segmentation, environmental classification, SLAM processing, and/or trajectory prediction.

At operation 810, the vehicle AI system generates a local environmental feature set. In some examples, the local environmental feature set includes environmental features associated with weather conditions, road conditions, visibility conditions, obstacle locations, traffic density, surface traction conditions, lane conditions, route conditions, and/or dynamic environmental changes. In some examples, the local environmental feature set is generated using one or more trained machine learning models associated with the vehicle AI engine 120 and/or the hazard prediction engine 125.

At operation 815, the vehicle AI system classifies an environmental condition. In some examples, the environmental condition includes a flooding condition, snow condition, icy-road condition, reduced-visibility condition, traffic condition, construction condition, debris condition, collision-risk condition, or combinations thereof. In some examples, the vehicle AI system classifies the environmental condition using one or more trained machine learning models configured to process the local environmental feature set generated at operation 810.

At operation 820, the vehicle AI system predicts a hazard region. In some examples, the hazard prediction engine 125 identifies one or more predicted hazard regions associated with unsafe operating conditions for the vehicle. In some examples, the predicted hazard regions correspond to geographic regions, route segments, lanes, intersections, parking areas, charging locations, and/or dynamically moving obstacle regions. In some examples, the hazard prediction engine 125 continuously updates the predicted hazard regions based on updated sensor data, telemetry data, and/or environmental data received asynchronously from local and remote systems.

In some examples, the vehicle AI system compares current or predicted hazard scores, environmental-risk scores, collision-risk scores, weather-severity scores, and/or route-safety scores against one or more thresholds. Reaching or crossing such thresholds can cause the vehicle AI system to proactively modify route-generation, braking, steering, lane-position, following distance, and/or vehicle speed.

At operation 825, the vehicle AI system determines one or more safe route regions. In some examples, the route prediction engine 130 identifies route segments that satisfy one or more safety thresholds associated with environmental conditions, traffic conditions, road conditions, charging availability, and/or vehicle operational constraints. In some examples, the vehicle AI system dynamically prioritizes route regions associated with reduced collision risk, reduced travel delay, improved traction conditions, reduced weather exposure, and/or improved vehicle-operating efficiency.

At operation 830, the vehicle AI system generates or updates a route. In some examples, the route prediction engine 130 generates a new route and/or dynamically modifies an existing route based on the safe route regions identified at operation 825. In some examples, the route is updated in response to changing weather conditions, changing traffic conditions, newly detected hazards, changing vehicle conditions, and/or updated telemetry information. In some examples, the route prediction engine 130 performs reinforcement-learning operations and/or predictive route optimization operations to improve future route-generation accuracy and hazard avoidance.

At operation 835, the vehicle AI system generates route commands for a vehicle controller. In some examples, the controller command generator 145 generates commands for steering, braking, acceleration, lane-position, route-following, and/or hazard-avoidance associated with the generated route.

At operation 840, the vehicle AI system transmits the route commands to the vehicle controller. In some examples, the controller command generator 145 transmits the route commands to the vehicle controller 150, which controls operation of one or more vehicle actuators 155 associated with steering systems, braking systems, propulsion systems, navigation systems, and/or autonomous-driving systems.

At operation 845, the vehicle AI system monitors vehicle progress along the route. In some examples, the vehicle AI system continuously receives updated telemetry data, sensor data, location data, and/or environmental data while the vehicle travels along the route. In some examples, the vehicle AI system monitors route progression, vehicle speed, environmental changes, obstacle movement, weather conditions, and/or deviations from predicted route behavior.

In some examples, while the vehicle travels along the route, the vehicle AI system 100 proactively modifies vehicle-operation commands before the vehicle reaches a predicted hazard region. For example, the vehicle AI system 100 can proactively reduce vehicle speed, modify steering behavior, increase braking responsiveness, modify lane positioning, modify following distance, and/or reroute the vehicle responsive to updated environmental conditions, updated telemetry data, and/or updated hazard predictions generated during operation of the vehicle.

At operation 850, the vehicle AI system generates hazard-avoidance feedback. In some examples, the hazard-avoidance feedback includes route-deviation information, obstacle-avoidance information, environmental-outcome information, actuator-response information, and/or prediction-accuracy information associated with operation of the vehicle along the route. In some examples, the hazard-avoidance feedback is processed using the vehicle feedback interpreter 160 and/or the machine learning update engine 165.

At operation 855, the vehicle AI system dynamically updates the route based on the hazard-avoidance feedback. In some examples, the route prediction engine 130 modifies route segments, navigation timing, lane selections, vehicle speeds, and/or hazard-avoidance operations based on the hazard-avoidance feedback generated at operation 850. In some examples, operation 855 includes generating updated route commands and re-performing operation 835 and operation 840 using updated environmental information and updated hazard predictions.

In some examples, the process 800 includes asynchronous data-flow operations in which sensor data, telemetry data, environmental data, and/or route data are processed concurrently across distributed computing resources associated with the vehicle edge computing system 115 and the cloud orchestration system 170. In some examples, the process 800 includes parallel machine learning inference operations performed simultaneously by the vehicle AI engine 120, the hazard prediction engine 125, and the route prediction engine 130 to reduce latency associated with hazard detection and route generation. In some examples, the process 800 includes synchronization loops in which telemetry information, environmental states, hazard states, and/or route states are synchronized using the telemetry and model synchronization engine 180. In some examples, the process 800 improves environmental awareness, hazard prediction accuracy, route-generation efficiency, and autonomous vehicle-operation responsiveness by dynamically integrating sensor fusion, environmental classification, predictive hazard analysis, and adaptive route orchestration.

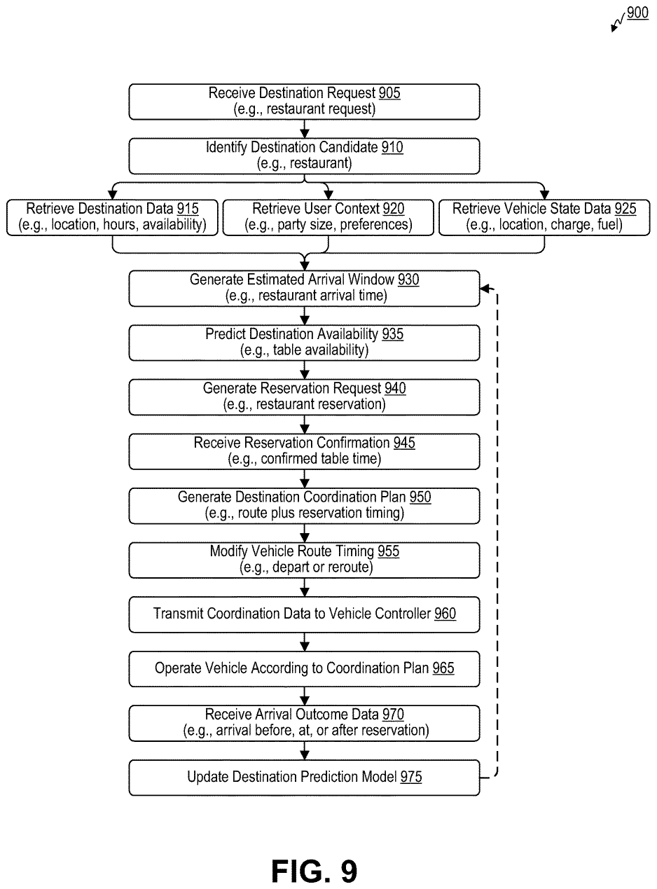

FIG. 9 is a flow diagram illustrating a process 900 associated with predictive destination coordination performed by the vehicle AI system 100. In some examples, the process 900 is performed using the vehicle AI engine 120, the route prediction engine 130, the controller command generator 145, the vehicle controller 150, the vehicle actuators 155, the cloud orchestration system 170, the data sources 175, one or more trained machine learning models associated with the machine learning system 4500, one or more computing systems such as the computing system 4600, or combinations thereof. In some examples, the process 900 coordinates destination selection, reservation timing, route timing, and vehicle operation to improve synchronization between vehicle travel and destination availability.

At operation 905, the vehicle AI system receives a destination request. In some examples, the destination request is received through the prompt of operation 205. For example, the destination request can include a spoken request such as “find a restaurant,” “take me to my next event,” “navigate to the nearest gas station,” or “route me to the grocery store.” In some examples, the destination request is derived from a calendar event associated with the user interfaces 310-340 and/or navigation operations associated with the user interfaces 410-430. In some examples, the destination request is derived from shopping-list operations associated with the user interfaces 510-550, such as identifying stores associated with shopping-list items. In some examples, the destination request is derived from vehicle-based sensor readings associated with the user interfaces 610-640, such as routing to a tire pump station responsive to tire-pressure sensor data or routing to a fueling station responsive to fuel-level sensor data. In some examples, the destination request is generated based on routing operations associated with the process 800, including rerouting around hazards and/or dynamically identifying safer route destinations.

At operation 910, the vehicle AI system identifies a destination candidate. In some examples, the destination candidate includes a restaurant, retail store, charging station, fueling station, event venue, parking location, service center, pickup location, drop-off location, or combinations thereof. In some examples, the vehicle AI system identifies the destination candidate using one or more trained machine learning models associated with the vehicle AI engine 120 and/or using retrieval operations from one or more network service systems 760.

At operation 915, the vehicle AI system retrieves destination data. In some examples, the destination data includes location information, operating hours, reservation availability, inventory availability, charging availability, fueling availability, parking availability, traffic information, weather information, and/or hazard information associated with the destination candidate. In some examples, the destination data is retrieved from the data sources 175 and/or one or more network service systems 760.

At operation 920, the vehicle AI system retrieves user context. In some examples, the user context includes calendar information, shopping-list information, user preferences, historical route information, historical reservation information, preferred driving styles, dietary preferences, accessibility preferences, household information, and/or passenger-count information. In some examples, the user context is derived from interactions associated with the user interfaces of FIGS. 3-6.

At operation 925, the vehicle AI system retrieves vehicle-state data. In some examples, the vehicle-state data includes vehicle location data, battery-charge data, fuel-level data, tire-pressure data, vehicle-range information, climate-control information, maintenance-status information, cargo-capacity information, and/or telemetry data associated with the vehicle. In some examples, the vehicle-state data is generated using the sensors 105 and/or the vehicle edge computing system 115.

At operation 930, the vehicle AI system generates an estimated arrival window. In some examples, the estimated arrival window is generated based on current vehicle location, route information, environmental conditions, traffic conditions, hazard information, and/or vehicle-operating constraints. In some examples, the route prediction engine 130 dynamically updates the estimated arrival window as route conditions change.

At operation 935, the vehicle AI system predicts destination availability. In some examples, the vehicle AI system predicts table availability at a restaurant, inventory availability at a retail store, charging-station availability, fueling-station availability, parking availability, and/or service availability associated with the destination candidate. In some examples, the vehicle AI system uses one or more trained machine learning models to predict destination availability based on historical trends, current network data, reservation information, environmental conditions, traffic conditions, and/or telemetry information.

At operation 940, the vehicle AI system generates a reservation request. In some examples, the reservation request includes a restaurant reservation request, a charging-station reservation request, a parking reservation request, a service appointment request, a pickup request, and/or another destination-coordination request. In some examples, the reservation request is automatically generated based on the estimated arrival window generated at operation 930 and the predicted destination availability generated at operation 935.

At operation 945, the vehicle AI system receives a reservation confirmation. In some examples, the reservation confirmation includes a confirmed reservation time, a queue position, a charging reservation window, a parking confirmation, an appointment confirmation, and/or other coordination information associated with the destination candidate.

At operation 950, the vehicle AI system generates a destination coordination plan. In some examples, the destination coordination plan includes coordinated route timing, departure timing, reservation timing, charging timing, parking timing, and/or hazard-avoidance timing associated with travel to the destination candidate. In some examples, the destination coordination plan is generated using the route prediction engine 130 and/or one or more trained machine learning models associated with the vehicle AI engine 120.

At operation 955, the vehicle AI system modifies vehicle route timing. In some examples, the route prediction engine 130 modifies departure timing, reroutes the vehicle, adjusts vehicle speed targets, modifies charging stops, and/or updates navigation timing based on the destination coordination plan generated at operation 950. In some examples, the vehicle AI system dynamically updates route timing responsive to changing environmental conditions, changing traffic conditions, updated reservation information, and/or predicted hazard regions identified through the process 800.

At operation 960, the vehicle AI system transmits coordination data to the vehicle controller. In some examples, the controller command generator 145 transmits route commands, timing commands, navigation commands, hazard-avoidance commands, charging commands, and/or destination-coordination commands to the vehicle controller 150.

At operation 965, the vehicle AI system operates the vehicle according to the destination coordination plan. In some examples, the vehicle autonomously drives according to the destination coordination plan using the vehicle controller 150 and the vehicle actuators 155. In some examples, the vehicle AI system causes one or more vehicle actuators 155 to assist with navigation operations, braking operations, acceleration operations, lane-position operations, charging operations, and/or hazard-avoidance operations while traveling to the destination.

At operation 970, the vehicle AI system receives arrival outcome data. In some examples, the arrival outcome data includes information indicating whether the vehicle arrived before, at, or after a reservation time and/or destination-availability window. In some examples, the arrival outcome data includes route-efficiency information, traffic-delay information, charging-delay information, environmental-condition information, and/or user-feedback information associated with the destination coordination plan.

At operation 975, the vehicle AI system updates a destination prediction model. In some examples, the machine learning update engine 165 updates one or more trained machine learning models associated with destination prediction, reservation timing, route prediction, charging coordination, parking coordination, and/or hazard prediction based on the arrival outcome data received at operation 970. In some examples, the process 900 uses reinforcement-learning operations and feedback retraining loops to improve future destination coordination accuracy, arrival-time prediction accuracy, reservation coordination accuracy, and route-generation efficiency over time.

In some examples, operations of the process 900 are performed asynchronously and/or at least partially in parallel using distributed processing resources associated with the vehicle edge computing system 115 and the cloud orchestration system 170. In some examples, the process 900 improves synchronization between vehicle routing operations, destination availability, reservation systems, shopping-list operations, vehicle telemetry conditions, and environmental hazard conditions by dynamically coordinating route timing, destination timing, and vehicle-control operations using predictive machine learning operations.

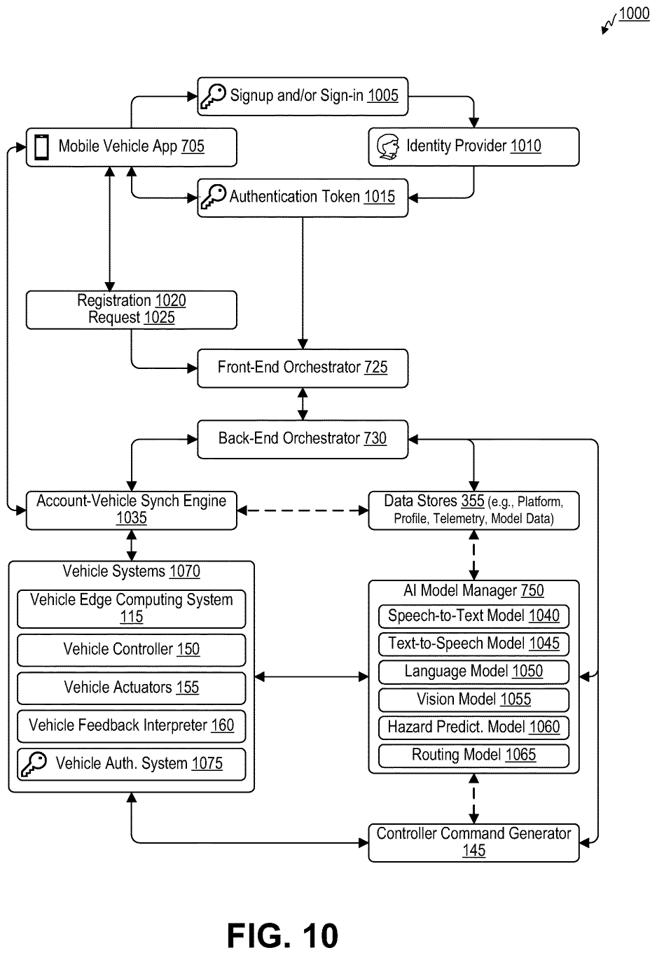

FIG. 10 is a block diagram illustrating an account-orchestration synchronization architecture 1000 associated with distributed vehicle-based artificial intelligence operations performed by the vehicle AI system 100. In some examples, the architecture 1000 coordinates authentication operations, account synchronization operations, distributed machine learning inference operations, vehicle-control operations, and multimodal AI interactions across mobile systems, vehicle systems, and cloud orchestration systems. In some examples, the architecture 1000 improves security, synchronization consistency, distributed inference efficiency, and low-latency coordination between user devices and vehicle systems.

The architecture 1000 includes the mobile vehicle app 705, the signup and/or sign-in system 1005, the identity provider 1010, the authentication token 1015, the registration request 1020, the front-end orchestrator 725, the back-end orchestrator 730, the account-vehicle synchronization engine 1035, the AI model manager 750, the speech-to-text model 1040, the text-to-speech model 1045, the language model 1050, the vision model 1055, the hazard prediction model 1060, the routing model 1065, the vehicle systems 1070, the vehicle authentication system 1075, the controller command generator 145, and the data stores 755. The speech-to-text model 1040 can be referred to as a transcription model. The text-to-speech model 1045 can be referred to as a speech synthesis model.

In some examples, the signup and/or sign-in system 1005 performs user-registration operations, credential-validation operations, account-linking operations, and/or session-establishment operations associated with the vehicle AI system 100. In some examples, the signup and/or sign-in system 1005 represents a first authentication factor associated with a multi-factor authentication architecture. For example, the first authentication factor can include a username-password combination, biometric login information, passkey information, mobile-device credentials, or combinations thereof.

In some examples, after successful authentication using the signup and/or sign-in system 1005, the identity provider 1010 generates the authentication token 1015. In some examples, the authentication token 1015 includes a session token, cryptographic token, access token, refresh token, OAuth token, JWT token, signed authentication credential, or combinations thereof. In some examples, the authentication token 1015 represents a second authentication factor associated with the multi-factor authentication architecture. In some examples, the authentication token 1015 is cryptographically validated by the front-end orchestrator 725, the back-end orchestrator 730, and/or the account-vehicle synchronization engine 1035 prior to permitting access to vehicle systems and/or AI operations.

In some examples, the vehicle authentication system 1075 performs vehicle-linked authentication operations associated with one or more physical authentication elements tied to a vehicle. For example, the vehicle authentication system 1075 can authenticate a cryptographic vehicle key, smart key, key fob, garage-door opener, secure vehicle hardware element, secure enclave, telematics module, near-field communication (NFC) device, Bluetooth Low Energy (BLE) device, ultra-wideband (UWB) device, or combinations thereof. In some examples, the vehicle authentication system 1075 represents a third authentication factor associated with the multi-factor authentication architecture. In some examples, multiple vehicle-linked authentication elements are independently authenticated, such that the vehicle authentication system 1075 provides both a third authentication factor and a fourth authentication factor. For example, a first vehicle-linked factor can correspond to a cryptographic key fob while a second vehicle-linked factor can correspond to a secure hardware module within the vehicle systems 1070.

In some examples, the multi-factor authentication architecture improves security associated with remote vehicle operations, remote telemetry access, autonomous vehicle-control operations, climate-control operations, route-generation operations, and/or vehicle-command generation. In some examples, the architecture 1000 reduces unauthorized access to vehicle systems by requiring synchronized validation of user credentials, cryptographic session tokens, and vehicle-linked authentication elements before permitting vehicle-control operations.

In some examples, the registration request 1020 includes account-registration information, account-linking information, vehicle-registration information, permission information, profile information, and/or synchronization information associated with a user account and one or more vehicles. In some examples, the front-end orchestrator 725 coordinates user-facing authentication operations, registration operations, and/or mobile-device synchronization operations. In some examples, the back-end orchestrator 730 coordinates distributed AI operations, account synchronization operations, telemetry synchronization operations, and/or vehicle-service coordination operations.

In some examples, the account-vehicle synchronization engine 1035 synchronizes user-account information, authentication states, vehicle states, telemetry states, route states, machine learning model states, and/or authorization states between the mobile vehicle app 705 and the vehicle systems 1070. In some examples, the account-vehicle synchronization engine 1035 performs asynchronous synchronization operations using distributed messaging systems, event streams, state-replication systems, and/or publish-subscribe architectures to reduce synchronization latency and improve consistency across distributed systems.

In some examples, the AI model manager 750 coordinates distributed inference operations using multiple specialized machine learning models. In some examples, the speech-to-text model 1040 processes voice-based inputs received through microphones associated with the mobile vehicle app 705, the user device interface 140, and/or the sensors 105. In some examples, the speech-to-text model 1040 converts spoken audio into structured textual representations, semantic embeddings, command representations, and/or prompt representations usable by the language model 1050, the routing model 1065, and/or the hazard prediction model 1060. In some examples, the speech-to-text model 1040 performs noise reduction, speaker identification, wake-word detection, contextual parsing, and/or low-latency streaming speech recognition to improve recognition accuracy within vehicle environments. Processing (e.g., interpreting, parsing) voice or speech clips using the speech-to-text model 1040 to generate text can be referred to as transcription.

In some examples, the language model 1050 processes prompts, contextual information, telemetry information, route information, environmental information, and/or historical interaction information to generate contextual responses, route requests, hazard-avoidance instructions, controller commands, shopping-list operations, calendar operations, and/or destination-coordination operations. In some examples, the language model 1050 coordinates inference operations with the routing model 1065 and/or the hazard prediction model 1060 using distributed inference orchestration performed by the AI model manager 750.

In some examples, the vision model 1055 processes image data, video data, depth data, and/or sensor-fusion data generated by the sensors 105. In some examples, the vision model 1055 performs object detection, semantic segmentation, occupancy-grid generation, lane detection, obstacle classification, driver monitoring, and/or environmental classification operations associated with operation of the vehicle systems 1070.

In some examples, the hazard prediction model 1060 predicts environmental hazards, collision risks, unsafe route regions, low-traction regions, flooding regions, construction hazards, and/or traffic hazards using telemetry data, environmental data, and/or sensor-fusion data. In some examples, the routing model 1065 generates and dynamically updates routes based on destination information, traffic information, environmental conditions, charging availability, and/or hazard predictions generated by the hazard prediction model 1060.

In some examples, the text-to-speech model 1045 generates speech-based outputs associated with responses generated by the language model 1050 and/or other AI models managed by the AI model manager 750. In some examples, the text-to-speech model 1045 converts textual responses into synthesized speech signals that are output through speakers associated with the mobile vehicle app 705, the user device interface 140, and/or the vehicle systems 1070. In some examples, the text-to-speech model 1045 dynamically adjusts speech timing, speech cadence, voice characteristics, and/or output formatting based on vehicle state, environmental noise levels, driver attention conditions, and/or contextual urgency associated with the generated response. Processing text using the text-to-speech model 1045 to generate speech or voice clips that “read” the text aloud can be referred to as speech synthesis or voice synthesis. The generated speech or voice clips can be referred to as synthesized speech or synthesized voice.

In some examples, the controller command generator 145 converts outputs generated by the routing model 1065, the hazard prediction model 1060, the language model 1050, and/or other AI models into executable vehicle-control commands. In some examples, the controller command generator 145 generates steering commands, braking commands, acceleration commands, lane-position commands, navigation commands, climate-control commands, and/or actuator-control commands for transmission to the vehicle systems 1070.

In some examples, the vehicle systems 1070 include the vehicle edge computing system 115, the vehicle controller 150, the vehicle actuators 155, and the vehicle feedback interpreter 160. In some examples, the vehicle systems 1070 perform local inference operations, low-latency vehicle-control operations, telemetry monitoring operations, and/or actuator-control operations associated with autonomous vehicle operation and/or driver-assistance operations.

In some examples, the data stores 755 store profile data, authentication data, telemetry data, route data, environmental data, machine learning model data, synchronization data, account-linkage data, and/or vehicle-state data associated with operation of the architecture 1000. In some examples, the architecture 1000 performs asynchronous synchronization loops in which authentication states, telemetry states, model states, route states, and/or vehicle states are continuously synchronized among the mobile vehicle app 705, the account-vehicle synchronization engine 1035, the AI model manager 750, and the vehicle systems 1070.

In some examples, the architecture 1000 supports parallel machine learning inference operations using the speech-to-text model 1040, the language model 1050, the vision model 1055, the hazard prediction model 1060, and the routing model 1065 simultaneously. In some examples, the architecture 1000 dynamically distributes inference workloads between the vehicle edge computing system 115 and cloud-based orchestration systems to reduce latency, reduce network dependence, improve responsiveness of vehicle operations, and improve scalability of distributed AI operations.

In some examples, the mobile vehicle app 705 exchanges user credentials with the identity provider 1010 to obtain the authentication token 1015 prior to performing vehicle-linked operations. In some examples, the mobile vehicle app 705 transmits a request to retrieve vehicle-account connection information associated with a vehicle-network platform and/or vehicle-service platform. In some examples, the front-end orchestrator 725 and/or the back-end orchestrator 730 authenticate the authentication token 1015 before retrieving redirect information, authorization information, and/or vehicle-account connection information associated with the vehicle-network platform. In some examples, redirect information is transmitted to the mobile vehicle app 705 to cause the mobile vehicle app 705 to redirect a user device to a vehicle-authentication interface associated with the vehicle-network platform.

In some examples, after vehicle authentication is completed through the vehicle-authentication interface, the mobile vehicle app 705 receives an authorization code and transmits the authorization code to the front-end orchestrator 725 and/or the back-end orchestrator 730. In some examples, the front-end orchestrator 725 and/or the back-end orchestrator 730 exchange the authorization code for vehicle-linked access tokens, refresh tokens, vehicle identifiers, user identifiers, and/or synchronization credentials associated with the vehicle systems 1070. In some examples, the account-vehicle synchronization engine 1035 stores vehicle-linked account information within the data stores 755 as a vehicle-linked subaccount associated with a primary user account.

In some examples, redirect information associated with vehicle authentication is retrieved by the front-end orchestrator 725 and/or the back-end orchestrator 730 instead of being retrieved directly by the mobile vehicle app 705. In some examples, retrieving redirect information through the orchestration systems reduces exposure of vehicle-platform credentials and improves security by reducing storage of authentication credentials within the mobile vehicle app 705.

In some examples, the mobile vehicle app 705 transmits voice requests received through the user device interface 140 to the front-end orchestrator 725 and/or the back-end orchestrator 730 after authentication of the authentication token 1015. In some examples, the back-end orchestrator 730 retrieves vehicle-linked account information associated with the authenticated user and interfaces with one or more vehicle-service systems through the vehicle service API 740 to retrieve telemetry information, vehicle-state information, route information, climate-control information, and/or vehicle-operation information associated with the vehicle systems 1070. In some examples, retrieved vehicle information is processed using the speech-to-text model 1040, the language model 1050, and/or the text-to-speech model 1045 to generate an AI-generated voice response that is transmitted to the mobile vehicle app 705 for audio playback to the user.

In some examples, the mobile vehicle app 705 transmits account-validation requests to the front-end orchestrator 725 and/or the back-end orchestrator 730 using the authentication token 1015. In some examples, the orchestration systems retrieve user-profile information associated with the authenticated user from the data stores 755 and determine whether the authenticated user is associated with a registered account. In some examples, when the authenticated user is not associated with a registered account, the mobile vehicle app 705 restricts access to one or more application features and redirects the user to a registration workflow associated with the signup and/or sign-in system 1005.

In some examples, the mobile vehicle app 705 transmits account-registration requests including user-profile information to the front-end orchestrator 725 and/or the back-end orchestrator 730 after successful authentication of the authentication token 1015. In some examples, the orchestration systems validate and store the user-profile information within the data stores 755 and transmit registration-status responses indicating successful registration or unsuccessful registration. In some examples, responsive to successful registration, the mobile vehicle app 705 enables access to vehicle-linked setup operations, synchronization operations, and/or distributed AI operations associated with the architecture 1000.

FIG. 11 is a perspective diagram 1100 illustrating a vehicle 1110 that includes various sensors and that can be used as part of a vehicle AI system. The vehicle 1110 may be, for example, an automobile, a truck, a bus, a train, a ground-based vehicle, an airplane, a helicopter, an aircraft, an aerial vehicle, a boat, a submarine, a watercraft, an underwater vehicle, a hovercraft, or a combination thereof. In some examples, the vehicle 1110 may be manned. In some examples, the vehicle may be at least partially controlled and/or used with sub-systems of the vehicle 1110, such as an Advanced Driver Assistance System (ADAS) of the vehicle 1110, In-Vehicle Infotainment (IVI) systems of the vehicle 1110, driving assistance systems of the vehicle 1110, a vehicle electronic control unit (ECU) of the vehicle 1110, or a combination thereof.

The vehicle 1110 includes a display 1120. The vehicle 1110 includes various sensors. The vehicle 1110 includes a first camera 1130A and a second camera 1130B at the front, a third camera 1130C and a fourth camera 1130D at the rear, and a fifth camera 1130E and a sixth camera 1130F on the top. The vehicle 1110 includes a first microphone 1135A at the front, a second microphone 1135B at the rear, and a third microphone 1135C at the top. The vehicle 1110 includes a first sensor 1140A on one side (e.g., adjacent to one rear-view mirror) and a second sensor 1140B on another side (e.g., adjacent to another rear-view mirror). The first sensor 1140A and the second sensor 1140B may include cameras, microphones, RADAR sensors, LIDAR sensors, or any other types of sensor(s) described herein. In some examples, the vehicle 1110 may include additional sensor(s) in addition to these sensors, or may be missing some of the illustrated sensors. In some examples, the vehicle 1110 may include one or more cameras and/or other sensors inside the vehicle, for instance directed toward a driver and/or one or more passengers of the vehicle. In some example, the vehicle 1110 can include one or more cameras and/or other sensors coupled to, or adjacent to, a steering wheel, the display 1120, and/or controls of the vehicle 1110.

In some examples, the display 1120 of the vehicle 1110 displays one or more output images toward a user of the vehicle 1110 (e.g., a driver and/or one or more passengers of the vehicle 1110. The output images can be based on the images captured by the first camera 1130A, the second camera 1130B, the third camera 1130C, the fourth camera 1130D, the fifth camera 1130E, the sixth camera 1130F, the first sensor 1140A, and/or the second sensor 1140B, for example with the user interfaces and/or processed image data overlaid.

FIG. 12A is a perspective diagram 1200 illustrating a front surface of a mobile handset 1210 that includes front-facing cameras and can be used as part of a vehicle AI system. The mobile handset 1210 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 1220 of the mobile handset 1210 includes a display 1240. The front surface 1220 of the mobile handset 1210 includes a first camera 1230A and a second camera 1230B. The first camera 1230A and the second camera 1230B can face the user, including the eye(s) of the user, while processed image data is displayed on the display 1240.

The first camera 1230A and the second camera 1230B are illustrated in a bezel around the display 1240 on the front surface 1220 of the mobile handset 1210. In some examples, the first camera 1230A and the second camera 1230B can be positioned in a notch or cutout that is cut out from the display 1240 on the front surface 1220 of the mobile handset 1210. In some examples, the first camera 1230A and the second camera 1230B can be under-display cameras that are positioned between the display 1240 and the rest of the mobile handset 1210, so that light passes through a portion of the display 1240 before reaching the first camera 1230A and the second camera 1230B. The first camera 1230A and the second camera 1230B of the perspective diagram 1200 are front-facing cameras. The first camera 1230A and the second camera 1230B face a direction perpendicular to a planar surface of the front surface 1220 of the mobile handset 1210. The first camera 1230A and the second camera 1230B may be two of the one or more cameras of the mobile handset 1210. In some examples, the front surface 1220 of the mobile handset 1210 may only have a single camera.

In some examples, the display 1240 of the mobile handset 1210 displays one or more output images toward the user using the mobile handset 1210. In some examples, the output images can include the processed image data. The output images can be based on the images captured by the first camera 1230A, the second camera 1230B, the third camera 1230C, and/or the fourth camera 1230D, for example with the user interfaces and/or processed image data overlaid.

In some examples, the front surface 1220 of the mobile handset 1210 may include one or more additional cameras in addition to the first camera 1230A and the second camera 1230B. In some examples, the front surface 1220 of the mobile handset 1210 may include one or more additional sensors in addition to the first camera 1230A and the second camera 1230B. In some cases, the front surface 1220 of the mobile handset 1210 includes more than one display 1240. For example, the one or more displays 1240 can include one or more touchscreen displays.

The mobile handset 1210 may include one or more speakers 1235A and/or other audio output devices (e.g., earphones or headphones or connectors thereto), which can output audio to one or more ears of a user of the mobile handset 1210. One speaker 1235A is illustrated in FIG. 12A, but it should be understood that the mobile handset 1210 can include more than one speaker and/or other audio device. In some examples, the mobile handset 1210 can also include one or more microphones (not pictured). In some examples, the audio output by the mobile handset 1210 to the user through the one or more speakers 1235A and/or other audio output devices may include, or be based on, audio recorded using the one or more microphones.

FIG. 12B is a perspective diagram 1250 illustrating a rear surface 1260 of a mobile handset that includes rear-facing cameras and that can be used as part of a vehicle AI system. The mobile handset 1210 includes a third camera 1230C and a fourth camera 1230D on the rear surface 1260 of the mobile handset 1210. The third camera 1230C and the fourth camera 1230D of the perspective diagram 1250 are rear-facing. The third camera 1230C and the fourth camera 1230D face a direction perpendicular to a planar surface of the rear surface 1260 of the mobile handset 1210.

The third camera 1230C and the fourth camera 1230D may be two of the one or more cameras of the mobile handset 1210. In some examples, the rear surface 1260 of the mobile handset 1210 may only have a single camera. In some examples, the rear surface 1260 of the mobile handset 1210 may include one or more additional cameras in addition to the third camera 1230C and the fourth camera 1230D. In some examples, the rear surface 1260 of the mobile handset 1210 may include one or more additional sensors in addition to the third camera 1230C and the fourth camera 1230D. In some examples, the first camera 1230A, the second camera 1230B, third camera 1230C, and/or the fourth camera 1230D may be examples of another camera or sensor discussed herein.

The mobile handset 1210 may include one or more speakers 1235B and/or other audio output devices (e.g., earphones or headphones or connectors thereto), which can output audio to one or more ears of a user of the mobile handset 1210. One speaker 1235B is illustrated in FIG. 12B, but it should be understood that the mobile handset 1210 can include more than one speaker and/or other audio device. In some examples, the mobile handset 1210 can also include one or more microphones (not pictured). In some examples, the mobile handset 1210 can include one or more microphones along and/or adjacent to the rear surface 1260 of the mobile handset 1210. In some examples, the audio output by the mobile handset 1210 to the user through the one or more speakers 1235B and/or other audio output devices may include, or be based on, audio recorded using the one or more microphones.

The mobile handset 1210 may use the display 1240 on the front surface 1220 as a pass-through display. For instance, the display 1240 may display output images, such as processed image data. The output images can be based on the images captured by the third camera 1230C and/or the fourth camera 1230D, for example with the user interfaces and/or processed image data overlaid. The first camera 1230A and/or the second camera 1230B can capture images of the user's eyes (and/or other portions of the user) before, during, and/or after the display of the output images with the processed content on the display 1240. This way, the sensor data from the first camera 1230A and/or the second camera 1230B can capture reactions to the processed content by the user's eyes (and/or other portions of the user).

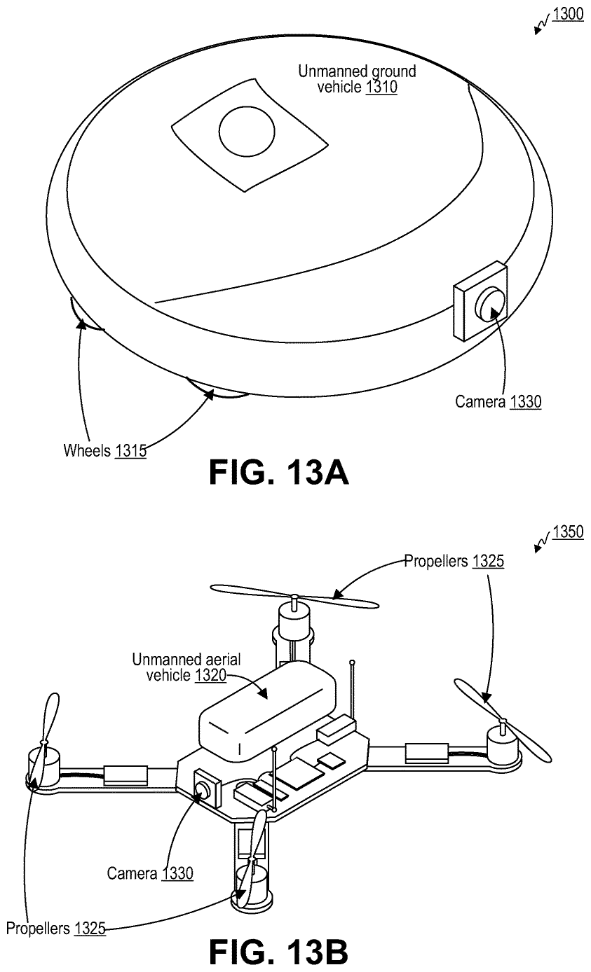

FIG. 13A is a perspective diagram 1300 illustrating an unmanned ground vehicle (UGV) 1310 that can be used as part of a vehicle AI system. The UGV 1310 illustrated in the perspective diagram 1300 of FIG. 13A may be an example of an imaging system. The UGV 1310 includes a camera 1330 along a front surface of the UGV 1310. In some examples, the UGV 1310 may include one or more additional cameras in addition to the camera 1330. In some examples, the UGV 1310 may include one or more additional sensors in addition to the camera 1330. The UGV 1310 includes multiple wheels 1315 along a bottom surface of the UGV 1310. The wheels 1315 may act as a conveyance of the UGV 1310, and may be motorized using one or more motors that may be actuated by a movement actuator of the UGV 1310. The movement actuator, the motors, and thus the wheels 1315, may be actuated to move the UGV 1310 along a path.

FIG. 13B is a perspective diagram 1350 illustrating an unmanned aerial vehicle (UAV) 1320 that can be used as part of a vehicle AI system. The UAV 1320 illustrated in the perspective diagram 1350 of FIG. 13B may be an example of an imaging system. The UAV 1320 includes a camera 1330 along a front portion of a body of the UAV 1320. In some examples, the UAV 1320 may include one or more additional cameras in addition to the camera 1330. In some examples, the UAV 1320 may include one or more additional sensors in addition to the camera 1330. The UAV 1320 includes multiple propellers 1325 along the top of the UAV 1320. The propellers 1325 may be spaced apart from the body of the UAV 1320 by one or more appendages to prevent the propellers 1325 from snagging on circuitry on the body of the UAV 1320 and/or to prevent the propellers 1325 from occluding the view of the camera 1330. The propellers 1325 may act as a conveyance of the UAV 1320, and may be motorized using one or more motors that may be actuated by a movement actuator of the UAV 1320. The movement actuator, the motors, and thus the propellers 1325, may be actuated to move the UAV 1320 along a path.

Where the imaging system is a vehicle, such as the vehicle 1110, the UGV 1310, and/or UAV 1320, the imaging system can include a simultaneous localization and mapping (SLAM) engine (e.g., a visual SLAM (VSLAM) engine), a path or route planning engine, and/or a movement actuator. The SLAM engine can locate the vehicle in the environment and can map the environment, the path planning engine may generate a path or route along which the vehicle is to move, and the movement actuator can actuate wheels, propellors, legs, and/or other conveyance actuators to move the vehicle along the planned path or route. In some examples, path planning engine may use a Dijkstra algorithm to plan the path, and/or may include stationary obstacle avoidance and/or moving obstacle avoidance in planning the path. In some examples, the path planning engine may include determinations as to how to best move the vehicle from a first pose to a second pose in planning the path. In some examples, the path planning engine may plan a path that is optimized to reach and observe every portion of a first region of an environment (e.g., a first set of one or more addresses or rooms in the environment) before moving on to a second region of the environment (e.g., the second set of one or more addresses or rooms of the environment) in planning the path. In some examples, the path planning engine may plan a path that is optimized to reach and observe a predetermined set of addresses or rooms in an environment as quickly as possible. In some examples, the path planning engine may plan a path that returns to a previously-observed room to observe a particular feature again to improve one or more map points corresponding the feature in the local map and/or global map. In some examples, the path planning engine may plan a path that returns to a previously-observed room to observe a portion of the previously-observed room that lacks map points in the local map and/or global map to see if any features can be observed in that portion of the room. The movement actuator may actuate one or more motors to actuate a motorized conveyance (e.g., the wheels 1315 or the propellers 1325) to move the vehicle along the path planned by the path planning engine.

In some cases, the propellers 1325 of the UAV 1320, or another portion of a vehicle (e.g., an antenna), may partially occlude the view of one of the one or more cameras in some images captured by the one or more cameras. In some examples, this partial occlusion may be masked out of any images in which the partial occlusion appears, for example as in a masking operation.

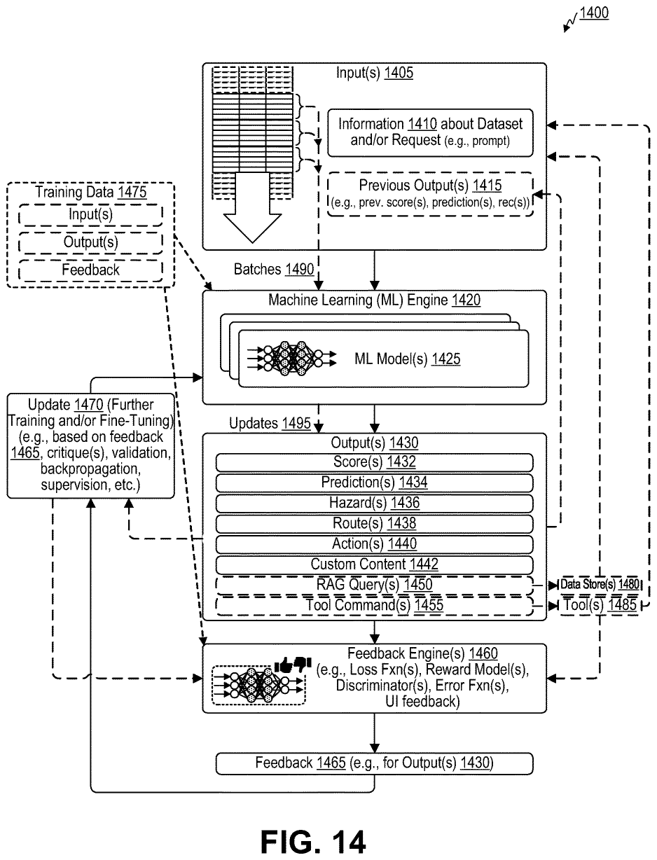

FIG. 14 is a block diagram illustrating an example of an AI system 1400 for training, use of, and/or updating of one or more machine learning model(s) 1425 that are used to generate score(s) 1432, prediction(s) 1434, hazard(s) 1436, route(s) 1438, action(s) 1440, custom content 1442, RAG query(s) 1450, and/or tool command(s) 1455. In some examples, the ML model(s) 1425 include, or are part of, the vehicle AI engine 120, the hazard prediction engine 125, the route prediction engine 130, the contextual response generator 135, and/or other machine learning systems associated with the vehicle AI system 100.

The ML model(s) 1425 can include, for instance, one or more machine-learning architectures and/or algorithms such as neural networks (NNs), artificial NNs (ANNs), convolutional NNs (CNNs), time-delay NNs (TDNNs), deep networks, feed-forward networks, recurrent NNs (RNNs), transformer-based models, autoencoders (AEs), variational AEs (VAEs), deep belief networks (DBNs), generative models, generative adversarial networks (GANs), conditional GANs (cGANs), diffusion models, autoregressive models, sequence-to-sequence (Seq2Seq) models, transformer-based language models (e.g., decoder-only, encoder-decoder, or encoder-only variants), or combinations thereof, which may be configured as mixtures-of-experts (MoE), may be instruction-tuned and/or alignment-tuned, and may be multimodal (e.g., jointly processing text with images, audio, video, and/or tabular features). In some examples, the ML model(s) 1425 may include encoder models that generate embeddings for retrieval and similarity search, graph neural networks for relational data, and/or other types of ML models such as support vector machines (SVMs), random forests (RFs), gradient-boosted decision trees, and/or generalized linear models. In some examples, the ML model(s) 1425 may include a U-Network (U-Net) architecture having a contracting path and an expansive path, and may include convolution, up-convolution, pooling, and skip connections to extract complex features while preserving and reconstructing spatial information. The ML model(s) 1425 may be deployed as a single model, an ensemble of models, and/or a pipeline of models (e.g., an embedding model feeding a retriever and a generator), and may support supervised, unsupervised, semi-supervised, self-supervised, reinforcement, and/or online/continual learning.

In some examples, any other artificial intelligence (AI) systems disclosed herein (e.g., AI algorithms, ML models, specific types of algorithms or models such as any of those listed above, or combinations thereof), can include the AI system 1400, the ML engine 1420, the ML model(s) 1425, and/or the feedback engine(s) 1460, or vice versa.

Within FIG. 14, a graphic representing the ML model(s) 1425 illustrates a set of circles connected to one another and organized in an array. Each of the circles can represent a node, a neuron, a perceptron, a layer, a portion thereof, or a combination thereof. In some examples, each of the circles (e.g., the nodes, neurons, and/or perceptrons) can correspond to specific hardware that stores and/or processes data on behalf of that node, neuron, and/or perceptron. Such hardware can include data storage element(s) (e.g., registers, flip-flops, on-chip memory, non-transitory computer-readable storage media, and/or other types of memory), processing element(s) (e.g., microprocessors, application-specific integrated circuits (ASICs), field programmable gate arrays (FPGAs), processors, controllers, and/or other types of processing elements), input connector(s), output connector(s), or combinations thereof.

The circles are arranged (within the array) in columns, which represent layers. The leftmost column of white circles represents an input layer. The rightmost column of white circles represents an output layer. Two columns (layers) of shaded circles between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 1425 are trained and/or updated. In some examples, each of the lines between nodes can correspond to specific hardware that stores, updates, and/or applies such weights, for instance including synaptic circuits that can include data storage element(s) (e.g., registers, flip-flops, on-chip memory, non-transitory computer-readable storage media, and/or other types of memory) for storing weights, processing element(s) (e.g., microprocessors, application-specific integrated circuits (ASICs), field programmable gate arrays (FPGAs), processors, controllers, and/or other types of processing elements), input connector(s), output connector(s), or combinations thereof. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions. In some examples, information is received, processed, and ultimately output in a flow from left to right through the layers of nodes, neurons, and/or perceptrons in the illustrated array. The weights can be referred to as synaptic weights and/or numeric weights, and can each represent the strength of a connection between two neurons.

In some examples, the ML model(s) 1425 can include a feed-forward network, in which case there are no feedback connections where outputs of the network are fed back into itself. In some cases, the ML model(s) 1425 can include a recurrent neural network, which can have loops that allow information to be carried across nodes while reading in input. In some cases, the network can include a convolutional neural network, which may not link every node in one layer to every other node in the next layer.

In some examples, the ML engine(s) 1420 may implement an inference runtime that improves the operation of the AI system 1400 by reducing latency, memory utilization, network overhead, and/or compute cycles associated with generating the output(s) 1430. For example, the inference runtime may perform request batching or micro-batching, caching of intermediate activations and/or prior inference results, scheduling of workloads across heterogeneous compute resources (e.g., CPUs, GPUs, TPUs, or accelerators), and/or selection among multiple model variants based on resource constraints or service-level objectives. In further examples, the ML model(s) 1425 may be optimized for deployment using quantization, pruning, distillation, compilation, or operator fusion, thereby reducing memory bandwidth and improving throughput while maintaining target accuracy. In some examples, the inference runtime enforces deterministic or constrained decoding (for generative models) and/or structured output validation, thereby reducing invalid outputs and avoiding repeated recomputation or retry loops.

One or more input(s) 1405 can be provided to the ML model(s) 1425. The ML model(s) 1425 can be trained by the ML engine 1420 (e.g., based on training data 1475) to generate one or more output(s) 1430. In some examples, the input(s) 1405 include information 1410. The information 1410 can include information received through an interactive user interface, such as a prompt (e.g., received through operation 205 and/or the interfaces of FIGS. 3-6, a chat-based interface or another type of interactive user interface discussed herein), a request, or another type of input that is based on at least one user interface input. The information 1410 can include sensor data captured by one or more sensors of a device (e.g., sensors 105 of a user device, mobile device, and/or vehicle, for instance as received in operation 210), such as image(s) and/or video(s) captured by image sensor(s) of camera(s), point cloud(s) captured by depth sensor(s), audio captured by microphone(s), or combinations thereof. Depth sensor(s) can include RADAR sensor(s), LIDAR sensor(s), structured light sensor(s), stereoscopic camera(s), or a combination thereof. In some examples the information 1410 can include location data received at operation 215, environmental data received at operation 220, telemetry data generated by the sensors 105, weather data, traffic data, route data (e.g., associated with the user interface 420 or the process 800 and/or the process 900), hazard data (e.g., associated with the process 800), calendar data (e.g., associated with the user interfaces 310-340), shopping-list data (e.g., user interfaces 520-550), vehicle-state data, vehicle telemetry information (e.g., associated with the user interfaces 610-640), destination data (e.g., associated with the process 900), and/or vehicle-controller data.

The input(s) 1405 can include information retrieved from data store(s) 1480, for instance via retrieval augmented generation (RAG) (e.g., via RAG query(s) 1450), and/or information generated using tool(s) 1485 (e.g., based on use of tool command(s) 1455).

The output(s) 1430 that the ML model(s) 1425 generate by processing the input(s) 1405 can include score(s) 1432, prediction(s) 1434, hazard(s) 1436, route(s) 1438, action(s) 1440, custom content 1442, RAG query(s) 1450, and/or tool command(s) 1455. In some examples, the score(s) 1432 include confidence scores, environmental-risk scores, route-safety scores, prediction-confidence scores, and/or authorization scores associated with operation of the vehicle AI system 100. In some examples, the prediction(s) 1434 include predicted vehicle behaviors, predicted environmental conditions, predicted traffic conditions, predicted destination availability, predicted hazard regions, and/or predicted arrival windows associated with the processes 200, 800, and/or 900. In some examples, the hazard(s) 1436 include predicted hazard regions associated with flooding, traffic, collisions, low-traction conditions, environmental hazards, and/or unsafe route regions as discussed with respect to the hazard prediction engine 125 and the process 800. In some examples, the route(s) 1438 include navigation routes, rerouting operations, route timing information, safe route regions, and/or destination-coordination routes associated with the route prediction engine 130, the user interface 420, and/or the process 900. In some examples, the action(s) 1440 include steering commands, braking commands, acceleration commands, climate-control commands, navigation commands, route-modification commands, autonomous-driving operations, and/or actuator-control commands generated by the controller command generator 145. In some examples, the custom content 1442 includes contextual responses, conversational responses, calendar information, shopping-list information, weather information, reservation information, route summaries, notifications, synthesized speech, graphical content, and/or outputs associated with the user interfaces of FIGS. 3-6. In some examples, the RAG query(s) 1450 include retrieval queries used to retrieve map data, traffic data, weather data, inventory data, calendar data, route data, and/or vehicle-related data from one or more data stores 1480. In some examples, the tool command(s) 1455 include structured commands configured to invoke external systems, APIs, vehicle-service systems, reservation systems, messaging systems, navigation systems, calendar systems, inventory systems, and/or vehicle-control systems.

The score(s) 1432 can include confidence scores associated with route predictions, hazard predictions, environmental classifications, destination predictions, speech-recognition, and/or vehicle-operation commands. In some examples, the score(s) 1432 include route-safety scores, environmental-risk scores, hazard-severity scores, destination-availability scores, authorization scores, telemetry-consistency scores, and/or prediction-confidence scores associated with operation of the vehicle AI system 100.

In some examples, the vehicle AI system 100 compares one or more score(s) 1432 against one or more thresholds to determine whether to generate route modifications, hazard notifications, action(s) 1440, route(s) 1438, tool command(s) 1455, and/or custom content 1442. Score(s) 1432 reaching or crossing corresponding thresholds can trigger proactive vehicle-operation modifications, autonomous-driving operations, rerouting, charging, fueling, climate control, hazard avoidance, and/or safety operations.

The prediction(s) 1434 can include predictions associated with vehicle routing, environmental conditions, traffic conditions, destination availability, charging availability, parking availability, user intent, hazard likelihood, route timing, and/or autonomous vehicle behavior. In some examples, the prediction(s) 1434 include predicted hazard regions generated by the hazard prediction engine 125, predicted arrival windows generated during the process 900, and/or predicted vehicle behaviors associated with the process 200.

The hazard(s) 1436 can include hazard classifications, predicted collision regions, flooding regions, low-traction regions, unsafe environmental conditions, obstacle regions, and/or dynamically changing hazard zones identified using the hazard prediction engine 125 and/or the process 800. In some examples, the route(s) 1438 include dynamically generated navigation routes, safe route regions, hazard-avoidance routes, destination-coordination routes, and/or autonomous-driving routes associated with the route prediction engine 130 and/or the user interface 420

The route(s) 1438 can include navigation routes, hazard-avoidance routes, destination-coordination routes, autonomous-driving routes, rerouting operations, route timing information, safe route regions, charging routes, fueling routes, shopping routes, and/or event-navigation routes generated by the route prediction engine 130 and/or the vehicle AI engine 120. In some examples, the route(s) 1438 are generated based on prompts received at operation 205, sensor data received at operation 210, location data received at operation 215, environmental data received at operation 220, and/or hazard predictions generated during the process 800. In some examples, the route(s) 1438 include routes associated with calendar events as illustrated in the user interfaces 310-340 and/or navigation operations illustrated in the user interface 420. In some examples, the route(s) 1438 include routes to stores associated with shopping-list operations illustrated in the user interfaces 510-550 and/or routes to tire pump stations, fueling stations, charging stations, parking locations, and/or other destinations associated with the user interfaces 610-640. In some examples, the route(s) 1438 are dynamically modified based on changing environmental conditions, traffic conditions, telemetry data, hazard regions, reservation timing, inventory availability, and/or destination availability.

The action(s) 1440 can include physical vehicle operations, controller operations, actuator operations, and/or autonomous-driving operations generated using the vehicle AI engine 120, the controller command generator 145, the vehicle controller 150, and/or the vehicle actuators 155. In some examples, the action(s) 1440 include steering operations, braking operations, acceleration operations, lane-position operations, climate-control operations, navigation operations, route-following operations, charging operations, parking operations, suspension operations, seat-adjustment operations, lighting operations, and/or hazard-avoidance operations associated with the process 200. In some examples, the action(s) 1440 include actions performed autonomously by the vehicle and/or actions performed using driver-assistance operations. In some examples, the action(s) 1440 are generated based on route(s) 1438, hazard(s) 1436, prediction(s) 1434, sensor data from the sensors 105, and/or prompts received through the interactive interface associated with operation 205.

The custom content 1442 can include contextual responses, conversational responses, synthesized speech, graphical content, notifications, route summaries, weather information, calendar information, shopping-list information, vehicle-status information, reservation information, hazard notifications, maintenance notifications, and/or other interface content generated using the contextual response generator 135 and/or the vehicle AI engine 120. In some examples, the custom content 1442 includes responses generated and output through the interactive interface at operation 265. In some examples, the custom content 1442 includes outputs associated with the user interfaces 310-340, 410-430, 510-550, and/or 610-640. For example, the custom content 1442 can include calendar-event responses, navigation responses, weather responses, shopping-list responses, tire-pressure responses, fuel-level responses, climate-control responses, vehicle-location responses, and/or other conversational outputs generated responsive to prompts received through the user device interface 140. In some examples, the custom content 1442 is generated using one or more trained machine learning models and dynamically customized based on telemetry data, environmental data, user preferences, route information, historical interactions, and/or vehicle-state information.

In some examples, the information 1410 includes image data, video data, audio data, biometric data, occupancy data, gaze data, pose data, gesture data, facial-expression data, speech data, and/or other sensor data captured using one or more sensors positioned within the vehicle, such as cameras, microphones, biometric sensors, and/or other sensors directed toward a driver, operator, passenger, or other occupant of the vehicle as discussed with respect to FIG. 11. In some examples, the ML model(s) 1425 process the sensor data to determine, predict, classify, and/or score (e.g., via score(s) 1432) user intent, user sentiment, user mood, user attention state, user distraction level, user fatigue level, user stress level, user engagement level, and/or predicted user behavior associated with operation of the vehicle. In some examples, the prediction(s) 1434 include predictions of user actions associated with driving operations, navigation operations, vehicle interactions, route modifications, braking operations, acceleration operations, steering operations, charging operations, climate-control operations, and/or interactions with one or more vehicle systems. In some examples, the hazard(s) 1436 are generated based at least in part on predicted user behavior, predicted distraction conditions, predicted fatigue conditions, and/or predicted unsafe operating conditions associated with one or more occupants of the vehicle. In some examples, the route(s) 1438 and/or action(s) 1440 are modified based on predicted user intent, sentiment, mood, attention state, distraction level, and/or fatigue level. For example, the vehicle AI system 100 can modify route timing, following distance, vehicle speed, lane-position behavior, braking behavior, climate-control operations, navigation operations, autonomous-driving operations, and/or hazard-avoidance operations based on predicted user conditions. In some examples, the custom content 1442 is dynamically customized based on predicted user intent, sentiment, mood, attention state, distraction level, and/or engagement level associated with occupant(s) of the vehicle.

The tool command(s) 1455 can include structured instruction(s), function call(s), procedure call(s), message(s), request(s), and/or other command data generated by the ML model(s) 1425 and/or the ML engine 1420 to cause one or more tool(s) 1485 to perform action(s). The tool command(s) 1455 can identify a target tool, operation, parameter(s), authorization or policy context, timing, callback information, schema information, and/or expected output information, and can be represented as text, JSON, XML, YAML, protocol buffers, schema-constrained output, executable code, a workflow, task, or job definition, a database query, an event, or a combination thereof.

The tool(s) 1485 can include software or hardware tool(s), service(s), application(s), agent(s), workflow engine(s), robotic or Internet-of-Things (IoT) device(s), data store(s), enterprise system(s), and/or document, messaging, calendar, payment, security, or network system(s) that can be invoked using the tool command(s) 1455. The ML engine 1420 and/or ML model(s) 1425 can interface with the tool(s) 1485 using one or more tool interface technologies, such as APIs (e.g., REST, GraphQL, RPC, and/or gRPC), webhook(s), message queue(s), event bus(es), plugin interface(s), browser automation interface(s), database interface(s), command-line interface(s) (CLIs), Model Context Protocol (MCP) interface(s) and/or server(s), Agent Communication Protocol (ACP) interface(s), agent-to-agent protocol(s), or a combination thereof. In some examples, an adapter, gateway, sandbox, permission boundary, policy engine, guardrail, validator, orchestrator, or other interface layer routes and/or validates the tool command(s) 1455 before the tool command(s) 1455 reach the tool(s) 1485.

In some examples, the ML model(s) 1425 generate the tool command(s) 1455 proactively and/or automatically when score(s) 1432 reach or cross threshold(s), when confidence reaches or crosses a threshold, and/or based on the prediction(s) 1434, hazard(s) 1436, route(s) 1438, action(s) 1440, and/or custom content 1442. For example, a tool command 1455 can initiate an action that follows a predicted outcome, intervene to change or avoid a predicted outcome, and/or perform, schedule, draft, transmit, approve, block, escalate, or otherwise implement a recommended action. The tool command(s) 1455 can be executed automatically after a trigger is satisfied or queued for review, approval, simulation, dry-run execution, or delayed execution.

In some examples, result(s) returned by the tool(s) 1485 can be used as additional input(s) 1405, previous output(s) 1415, and/or feedback 1465. For instance, a tool response can indicate whether a tool command 1455 was syntactically or semantically valid, authorized, executable, successful, rejected, rolled back, duplicative, ill-timed, unsafe, inconsistent with a current tool state, and/or otherwise appropriate. Such information can indicate whether the tool command 1455, score(s) 1432, prediction(s) 1434, and/or hazard(s) 1436, route(s) 1438, action(s) 1440, and/or custom content 1442 were accurate, reliable, calibrated, useful, and/or aligned with an intended purpose.

In some examples, the ML model(s) 1425 (and/or other elements of the AI system 1400, such as a pre-processor) can perform certain data formatting, conversion, normalization, and/or standardization operations. For instance, in some examples, the input(s) 1405 can be received from multiple data structures, multiple types of data structures (e.g., databases, tables, linked lists, arrays, dictionaries, spreadsheets, text extracted from documents, slide decks), multiple devices, multiple types of devices (e.g., mobile handsets, laptops, tablets, desktops, servers), and/or in multiple different formats. To improve accuracy of the output(s) 1430, the ML model(s) 1425 (and/or a pre-processor of the AI system 1400) can convert data from a first format to a second format, normalize formats, convert non-standardized data entries into a standardized format, translate text from a first language to a second language, convert amounts from a first currency to a second currency, or a combination thereof. This pre-processing can allow data from different sources, formats, and/or devices to interoperate, be integrated and/or meshed together to provide answers and/or insights (in the form of the output(s) 1430) that could not be obtained from individual datasets without such integration. In some examples, the ML model(s) 1425 (and/or a pre-processor of the AI system 1400) can improve security and/or privacy (e.g., reducing data leakage risk) by tokenizing, redacting, encrypting, obfuscating, and/or transforming sensitive fields prior to inference; encrypting feature vectors, embeddings, and/or retrieved content at rest and/or in transit; enforcing tenant-and role-based access controls for retrieval from the data store(s) 1480; and/or applying policy-based filtering so that retrieval-augmented content is constrained to authorized sources. In some examples, cryptographic key operations are performed via hardware security modules (HSMs) or secure enclaves, and the AI system 1400 persists only minimized or transformed representations (e.g., hashes, tokens, or embeddings) to reduce exposure while preserving model utility.

In some examples, the ML model(s) 1425 can identify something in the input(s) 1405 about which the data store(s) 1480 include additional information, and can fashion at least one query (e.g., the RAG query(s) 1450) for the data store(s) 1480 to retrieve the additional information from the data store(s) 1480. For instance, if the information 1410 references a specific model of device, the RAG query(s) 1450 can include one or more queries of the data store(s) 1480 for additional information about the specific model of device, for instance to retrieve its components, configurations, settings, firmware updates, ranges of optimal operating parameters (e.g., temperature, clock speed, and so forth), or a combination thereof. The additional information retrieved from the data store(s) 1480 using the RAG query(s) 1450 can be used as part of the input(s) 1405 (e.g., as part of the information 1410 and/or part of the previous output(s) 1415) for further passes of data processing by the ML model(s) 1425.

In examples that employ RAG, the AI system 1400 may improve computational efficiency and output reliability by maintaining one or more searchable indexes over the data store(s) 1480, such as a vector index for approximate nearest-neighbor retrieval, a lexical/inverted index, or a hybrid index combining both. The ML engine(s) 1420 may generate embeddings for the query(s) 1450 and/or for candidate documents, retrieve a top-K set of candidates using the index, and optionally apply a re-ranking stage (e.g., a cross-encoder or scoring model) before incorporating selected passages into model inputs. In some examples, the AI system 1400 caches retrieved results (e.g., keyed by an embedding hash, tenant identifier, and/or policy context) to reduce repeated index lookups and network round trips, and attaches provenance metadata (e.g., document identifiers, timestamps, and/or citation pointers) to retrieved content used to produce the output(s) 1430, thereby improving auditability and traceability.

In some examples, certain output(s) 1430 (e.g., the score(s) 1432, prediction(s) 1434, hazard(s) 1436, route(s) 1438, action(s) 1440, custom content 1442, RAG query(s) 1450, and/or tool command(s) 1455) can be used as part of the input(s) 1405 to the ML model(s) 1425 (e.g., as previous output(s) 1415) for identifying other output(s) 1430. For instance, the score(s) 1432 can be processed as previous output(s) 1415 by the ML model(s) 1425 to generate hazard(s) 1436, route(s) 1438, action(s) 1440, custom content 1442, RAG query(s) 1450, tool command(s) 1455, and/or other output(s) 1430. In some examples, based on receipt of the input(s) 1405, the ML model(s) 1425 select the output(s) 1430 from a list of possible outputs, rank possible outputs by likelihood, probability, and/or confidence, and/or generate output(s) 1430 using generative AI content generation techniques, for instance using an LLM to generate custom text and/or graphics responsive to a prompt in the input(s) 1405.

In some examples, the ML model(s) 1425 can generate intermediate data based on the input(s) 1405, and can generate the output(s) 1430 based on the intermediate data. For instance, the ML model(s) 1425 can process the information 1410 to generate a user description, identify user behaviors, infer user intent or goals, categorize the user into a category (e.g., by behavior, intent, demographics, goals, or a combination thereof), or a combination thereof, and can then generate the output(s) 1430 based on this intermediate data to improve customization and/or personalization.

In some examples, the ML system repeats the process illustrated in FIG. 14 multiple times to generate the output(s) 1430 in multiple passes, using some of the output(s) 1430 from earlier passes as some of the input(s) 1405 in later passes (e.g., as some of the previous output(s) 1415). For instance, in a first illustrative example, in a first pass, the ML model(s) 1425 can identify the score(s) 1432 and/or the prediction(s) 1434 based on input of the information 1410 into the ML model(s) 1425. In a second pass, the ML model(s) 1425 can identify the hazard(s) 1436, route(s) 1438, action(s) 1440, and/or custom content 1442 based on input of the information 1410 and the previous output(s) 1415 (that includes the score(s) 1432 and/or prediction(s) 1434 from the first pass) into the ML model(s) 1425. Different subsets from output(s) 1430 can be split between the first pass and second pass.

In another illustrative example, a later pass can identify tool command(s) 1455 based on the information 1410, score(s) 1432, prediction(s) 1434, hazard(s) 1436, route(s) 1438, action(s) 1440, custom content 1442, RAG result(s), and/or tool result(s). For example, when a score reaches or crosses a threshold and/or prediction(s) 1434 indicate a likely outcome, the ML model(s) 1425 can generate a tool command 1455 that causes a tool 1485 to proactively block, pause, message, route, escalate, log, create, update, query, retrieve, simulate, test, or otherwise act, including to promote a desirable predicted outcome or prevent an undesirable predicted outcome. The tool command(s) 1455 can also perform or help perform the action(s) 1440.

In some examples, the ML system includes one or more feedback engine(s) 1460 that generate and/or provide feedback 1465 about the output(s) 1430. The feedback 1465 can indicate how well the output(s) 1430 align to corresponding expected output(s), how well the output(s) 1430 serve their intended purpose, or a combination thereof. In some examples, the feedback engine(s) 1460 include loss function(s), reward model(s) (e.g., other ML model(s) that are used to score the output(s) 1430), discriminator(s), error function(s) (e.g., in back-propagation), user interface feedback received via a user interface from a user, or a combination thereof. In some examples, the feedback 1465 can include one or more alignment score(s) that score a level of alignment between the output(s) 1430 and the expected output(s) and/or intended purpose.

The ML engine 1420 of the ML system can update (e.g., further train and/or fine-tune) the ML model(s) 1425 based on the feedback 1465 to perform an update 1470 (e.g., further training and/or fine-tuning) of the ML model(s) 1425 based on the feedback 1465. In some examples, the feedback 1465 includes positive feedback, for instance indicating that the output(s) 1430 closely align with expected output(s) and/or that the output(s) 1430 serve their intended purpose. In some examples, the feedback 1465 includes negative feedback, for instance indicating a mismatch between the output(s) 1430 and the expected output(s), and/or that the output(s) 1430 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback.

In response to positive feedback, the ML engine 1420 can perform update 1470 to strengthen and/or reinforce weights, connections, and/or hyperparameters associated with generation of the output(s) 1430, encouraging similar output(s) for similar input(s). In response to negative feedback, the ML engine 1420 can weaken and/or remove such weights, connections, and/or hyperparameters to discourage similar output(s) for similar input(s). In this way, update 1470 can improve accuracy of the ML model(s) 1425, for instance by reducing false positive(s) and/or false negative(s).

For instance, if the score(s) 1432, prediction(s) 1434, hazard(s) 1436, route(s) 1438, action(s) 1440, custom content 1442, and/or tool command(s) 1455 are used in a subsequent process (e.g., {relevant examples} or an action performed by the tool(s) 1485), success of that process can be interpreted as positive feedback 1465, while failure or lack of success can be interpreted as negative feedback 1465. Either way, update 1470 can improve the AI system 1400 and the overall system by improving the consistency with which the subsequent process succeeds.

In some examples, the tool(s) 1485 are a source of feedback 1465. For instance, the feedback engine(s) 1460 can receive or generate feedback 1465 based on validity, policy, or permission check(s), execution result(s), exception(s), latency, retry count(s), rollback(s), downstream state change(s), audit log(s), confirmation(s), rejection(s), or other information associated with a tool command 1455 and/or tool 1485. Valid, authorized, successful, and/or well-timed tool command(s) 1455 can provide positive feedback; invalid, unauthorized, unsuccessful, unsafe, ill-timed, rejected, or state-inconsistent tool command(s) 1455 can provide negative feedback for updating, recalibrating, reweighting, or avoiding similar future output(s).

In some examples, the AI system 1400 monitors model performance and data drift to maintain reliable operation over time. For example, the ML engine(s) 1420 and/or feedback engine(s) 1460 may compute drift metrics over input feature distributions, embedding distributions, and/or output distributions, and may monitor performance metrics such as false positives, false negatives, calibration error, latency, and throughput. When drift or degradation exceeds one or more thresholds, the ML engine 1420 and/or feedback engine(s) 14560 may trigger an update 570, for instance including retraining, fine-tuning, re-calibration, and/or selection of a different model checkpoint, and/or may roll back deployment to a prior checkpoint to restore stability. In some examples, the update process is performed in a staged deployment (e.g., shadow mode, canary release, or A/B testing) to validate improvements prior to wider rollout.

In some examples, the ML engine 1420 can also perform an initial training of the ML model(s) 1425 before the ML model(s) 1425 are used to generate the output(s) 1430 based on the input(s) 1405. During the initial training, the ML engine 1420 can train the ML model(s) 1425 based on training data 1475. In some examples, the training data 1475 includes examples of input(s) (of any input types discussed with respect to the input(s) 1405), output(s) (of any output types discussed with respect to the output(s) 1430), and/or feedback (of any feedback types discussed with respect to the feedback 1465). In some cases, positive feedback in the training data 1475 can be used to perform positive training, to encourage the ML model(s) 1425 to generate output(s) similar to the output(s) in the training data given input of the corresponding input(s) in the training data. In some cases, negative feedback in the training data 1475 can be used to perform negative training, to discourage the ML model(s) 1425 from generating output(s) similar to the output(s) in the training data given input of the corresponding input(s) in the training data. In some examples, the training of the ML model(s) 1425 (e.g., the initial training with the training data 1475, update(s) 1470 based on the feedback 1465, and/or other modification(s)) can include fine-tuning of the ML model(s) 1425, retraining of the ML model(s) 1425, or a combination thereof.

In some examples, the ML model(s) 1425 can include an ensemble of multiple ML models, and the ML engine 1420 can curate and manage the ML model(s) 1425 in the ensemble. The ensemble can include ML model(s) 1425 that are different from one another to produce different respective outputs, which the ML engine 1420 can average (e.g., mean, median, and/or mode) to identify the output(s) 1430. In some examples, the ML engine 1420 can calculate the standard deviation of the respective outputs of the different ML model(s) 1425 in the ensemble to identify a level of confidence in the output(s) 1430. In some examples, the standard deviation can have an inverse relationship with confidence. For instance, if the respective outputs of the different ML model(s) 1425 are very different from one another (and thus have a high standard deviation above a threshold), the confidence that the output(s) 1430 are accurate may be low (e.g., below a threshold). On the other hand, if the respective outputs of the different ML model(s) 1425 are equal or very similar to one another (and thus have a low standard deviation below a threshold), the confidence that the output(s) 1430 are accurate may be high (e.g., above a threshold).

In some examples, the ML engine(s) 1420 may compute one or more uncertainty measures associated with the output(s) 1430, such as predictive variance across an ensemble, entropy of a probability distribution, disagreement among models, or other confidence indicators. The AI system 1400 may further calibrate confidence values (e.g., via temperature scaling, isotonic regression, or other calibration techniques) to better align reported confidence with observed correctness. Based on the uncertainty and/or calibrated confidence, the ML engine(s) 1420 may abstain from producing a definitive output, route the input(s) 1405 to an alternate model or a rules-based fallback, invoke additional retrieval passes, and/or may escalate to a human review workflow. These controls can reduce erroneous outputs, reduce downstream error propagation, and improve the overall reliability of the computing system under distribution shift or adversarial/noisy inputs.

In some examples, different ML model(s) 1425 in the ensemble can include different types of models. For instance, in some examples, an ensemble can include a NN and a SVM that are both trained to process the input(s) 1405 to generate at least a subset of the output(s) 1430. In some examples, the ensemble may include different ML model(s) 1425 that are trained to process different inputs of the input(s) 1405 and/or to generate different outputs of the output(s) 1430. For instance, in some examples, a first model (or set of models) can process the input(s) 1405 to generate the score(s) 1432, a second model (or set of models) can process the input(s) 1405 to generate the prediction(s) 1434, a third model (or set of models) can process the input(s) 1405 to generate the hazard(s) 1436, a fourth model (or set of models) can process the input(s) 1405 to generate the route(s) 1438, a fifth model (or set of models) can process the input(s) 1405 to generate the action(s) 1440, a sixth model (or set of models) can process the input(s) 1405 to generate the custom content 1442 a seventh model (or set of models) can process the input(s) 1405 to generate the RAG query(s) 1450, and an eight model (or set of models) can process the input(s) 1405 to generate the tool command(s) 1455. In some examples, the ML engine 1420 can choose specific ML model(s) 1425 to be included in the ensemble because the chosen ML model(s) 1425 are effective at accurately processing particular types of input(s) 1405, are effective at accurately generating particular types of output(s) 1430, are generally accurate, process input(s) 1405 quickly, generate output(s) 1430 quickly, are computationally efficient, have higher or lower degrees of uncertainty than other models in the ensemble, or a combination thereof.

In some examples, one or more of the ML model(s) 1425 can be initialized with weights, connections, and/or hyperparameters that are selected randomly. This can be referred to as random initialization. These weights, connections, and/or hyperparameters are modified over time through training (e.g., initial training with the training data 1475 and/or update(s) 1470 based on the feedback 1465), but the random initialization can still influence the way the ML model(s) 1425 process data, and thus can still cause different ML model(s) 1425 (with different random initializations) to produce different output(s) 1430. Thus, in some examples, different ML model(s) 1425 in an ensemble can have different random initializations.

As an ML model (of the ML model(s) 1425) is trained (e.g., along the initial training with the training data 1475, update(s) 1470 based on the feedback 1465, and/or other modification(s)), different versions of the ML model at different stages of training can be referred to as checkpoints. In some examples, after each new update to a model (e.g., update 1470) generates a new checkpoint for the model, the ML engine 1420 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 1420 produces a benchmark score for one or more checkpoint(s) of one or more ML model(s) 1425, and keeps the checkpoint(s) that have the best (e.g., highest or lowest) benchmark scores in the ensemble. In some examples, if a new checkpoint is worse than an older checkpoint, the ML engine 1420 can revert to the older checkpoint. The benchmark score for a checkpoint can represent a level of accuracy of the checkpoint and/or number of errors (e.g., false positive or false negative) by the checkpoint during the testing (e.g., against the testing data and/or the validation data). In some examples, an ensemble of the ML model(s) 1425 can include multiple checkpoints of the same ML model.

In some examples, the ML model(s) 1425 can be trained and/or updated (e.g., with training data 1475 and/or the update 1470) over a number of epochs, where each epoch includes one or more batches of training data. A batch refers to a subset of the training data that is processed together in a single forward and backward pass during model training. Processing data in batches can improve computational efficiency and stabilize gradient updates. As training progresses across multiple epochs, the model parameters are iteratively refined, enabling the model to generalize better to unseen data. The use of multiple epochs and batch-based updates allows the model to progressively learn complex patterns and reduce prediction error, thereby improving accuracy and/or robustness of the ML model(s) 1425 over time. The number of epochs and batch size may be predetermined or dynamically adjusted based on performance of the ML model(s) 1425, convergence criteria, and/or available computational resources.

In some examples, the ML model(s) 1425 can be modified, either through the initial training (with the training data 1475), an update 1470 based on the feedback 1465, or another modification to introduce randomness, variability, and/or uncertainty into an ensemble of the ML model(s) 1425. In some examples, such modification(s) to the ML model(s) 1425 can include dropout (e.g., Monte Carlo dropout), in which one or more weights or connections are selected at random and removed. In some examples, dropout can also be performed during inference, for instance to modify the output(s) 1430 generated by the ML model(s) 1425. Bayesian machine learning can be used to implement random dropout, random initialization, and/or other randomization-based modifications to the ML model(s) 1425. In some examples, the modification(s) to the ML model(s) 1425 can include a hyperparameter search and/or adjustment of hyperparameters. The hyperparameter search can involve training and/or updating different ML models 1425 with different values for hyperparameters and evaluating the relative performance of the ML models 1425 (e.g., against testing data and/or validation data where the correct output(s) are known) to identify which of the ML models 1425 performs best. Hyperparameters can include, for instance, temperature (e.g., influencing level creativity and/or randomness), top P (e.g., influencing level creativity and/or randomness), frequency penalty (e.g., to prevent repetitive language between one of the output(s) 1430 and another), presence penalty (e.g., to encourage the ML model(s) 1425 to introduce new data in the output(s) 1430), other parameters or settings, or a combination thereof. The different hyperparameters can be modified to improve accuracy and reduce inaccurate generated outputs (e.g., by reducing creativity or randomness, and/or reducing penalties for frequency or presence), to improve creativity (e.g., by increasing creativity or randomness, and/or increasing or decreasing penalties for frequency or presence), or a combination thereof.

In some examples, the ML model(s) 1425 can be trained and/or updated (e.g., with training data 1475 and/or update 1470) using supervised learning, unsupervised learning, semi-supervised learning, reinforcement learning, self-supervised learning, transfer learning, and/or optimization algorithms such as gradient descent and its variants (e.g., stochastic gradient descent (SGD) or adaptive moment estimation (Adam)). These techniques can use labeled data, unlabeled data, generated supervisory signals, cumulative rewards, pre-trained models, and/or iterative parameter adjustment to improve the ML model(s) 1425 for classification, regression, clustering, dimensionality reduction, sequential decision-making, and/or other tasks.

In some examples, the ML engine 1420 can perform retrieval-augmented generation (RAG) using the model(s) 1425. For instance, in some examples, the ML engine 1420 can pre-process the input(s) 1405 by retrieving additional information from one or more data store(s) 1480 (e.g., any of the databases and/or other data structures discussed herein) and using the additional information to enhance the input(s) 1405 before the input(s) 1405 are processed by the ML model(s) 1425 to generate the output(s) 1430. For instance, in some examples, the enhanced versions of the input(s) 1405 can include the additional information that the ML engine 1420 retrieved from the one or more data store(s) 1480. In some examples, the artificial intelligence system 1400 can retrieve the additional information from one or more data store(s) 1480 by querying the data store(s) 1480 using RAG query(s) 1450 generated by the ML model(s) 1425 (or extracted from the input(s) 1405 using the ML model(s) 1425). In some examples, this RAG process provides the ML model(s) 1425 with more relevant information, allowing the ML model(s) 1425 to generate more accurate and/or personalized output(s) 1430.

In some examples, the analyses and data processing operations discussed as being performed by the ML model(s) 1425 can be performed by different types of AI algorithm(s) (other than ML model(s)) in addition to, or instead of, being performed by the ML model(s) 1425. For instance, in some examples, AI algorithm(s) can be used to process the input(s) 1405 (e.g., the information 1410 and/or the previous output(s) 1415) to generate the output(s) 1430 (e.g., the score(s) 1432, the prediction(s) 1434, the hazard(s) 1436, the route(s) 1438, the action(s) 1440, the custom content 1442, and/or the RAG query(s) 1450). Examples of AI algorithm(s) that the 1400 can use in this way can include rule-based AI systems (e.g., with pre-defined rules), expert-based AI systems (e.g., where experts define the rules), heuristic-based AI systems (e.g., where various key values are combined using a specific equation or formula to generate a heuristic that the AI system 1400 compares to a heuristic threshold or to other generated heuristics to make a decision), genetic AI algorithms (e.g., that evolve solutions through iterative processes but without learning), search algorithms (e.g., that explore a search space to find optimal solutions to problems), symbolic AI algorithms (e.g., that focus on representing knowledge and reasoning using symbols and logical rules), or combinations thereof.

In some examples, the input(s) 1405 are received as a data stream, with a high volume of data continuing to be received and processed through the ML model(s) 1425 over time. For instance, in some examples, the input(s) 1405 can include transactions processed across numerous users, accounts, payment instruments, devices, and/or financial institutions. In some cases, the input(s) 1405 received and processed can include hundreds, thousands, tens of thousands, hundreds of thousands, millions, tens of millions, hundreds of millions, or even billions of transactions (or other records) per second, per minute, per hour, or the like. Furthermore, in some examples, the 1400 may be given a limited amount of time (from the time of receipt of given input(s) 1405) to generate certain output(s) 1430 (e.g., score(s) 1432, prediction(s) 1434, hazard(s) 1436, route(s) 1438, action(s) 1440, and/or custom content 1442), in some cases just a few minutes, seconds, or milliseconds. These volumes of data can be impossible for human beings to process and generate score(s) 1432, prediction(s) 1434, hazard(s) 1436, route(s) 1438, action(s) 1440, custom content 1442, and/or other output(s) 1430 in such short timeframes. The ML model(s) 1425 can thus provide a technical improvement by being able to process high volumes of data within short timeframes.

In some examples, the AI system 1400 can extract batches 1490 of data from the input(s) 1405 (e.g., data stream) dynamically and in real-time (or near-real-time) as the data from the input(s) 1405 continue to be received by the AI system 1400 over time. In some examples, the AI system 1400 can process the batches 1490 of data (e.g., using the ML model(s) 1425) dynamically and in real-time (or near-real-time) as the data from the input(s) 1405 continue to be received by the AI system 1400 to generate updates 1495 to one or more outputs of the output(s) 1430.

For instance, each batch 1490 can be processed by the ML model(s) 1425 to generate an update 1495. The AI system 1400 (e.g., the ML engine 1420 and/or ML model(s) 1425) can update previous output(s) 1430 based on newer batches 1490 sequentially, in parallel, after a threshold number of batches is received, or a combination thereof. The update(s) 1495 can include feedback 1465, training data, fine-tuning data, context data, and/or model parameters for training, re-training, fine-tuning, and/or updating the ML model(s) 1425, in addition to or instead of updating the output(s) 1430.

In some examples, functional subsystems may be implemented as part of the components shown in the AI system 1400. For example, the ML engine(s) 1420, ML model(s) 1425, data store(s) 1480, feedback engine(s) 1460, output(s) 1430, and/or tool(s) 1485 may implement pre-processing and feature-engineering; embedding generation, indexing, and re-ranking; model registry, checkpoint, and deployment management; and/or policy and guardrail functions such as access control, retrieval filtering, structured output validation, tool-command validation, constrained decoding, permission checking for tool(s) 1485, redaction, and escalation routing.

The architecture of the AI system 1400 provides technical improvements by transforming and structuring input data into computational representations suitable for efficient inference, using indexed retrieval and caching to reduce repeated searches and network round trips, optimizing inference execution through batching, hardware-aware scheduling, quantization, distillation, and/or other model optimization techniques, and improving runtime reliability through calibrated uncertainty estimation, abstention/fallback routing, drift monitoring, validated tool invocation, tool-result feedback, and checkpoint-based rollback. These mechanisms can reduce inference latency, increase throughput under high-volume streams, reduce memory bandwidth consumption, reduce recomputation and retries, and improve accuracy and/or calibration under changing data conditions.

In some examples, the AI system 1400 dynamically coordinates generation of hazard predictions, navigation routes, autonomous-driving operations, contextual responses, retrieval operations, and external tool invocations using multiple specialized machine learning models operating concurrently across distributed computing systems. In some examples, the AI system improves responsiveness and operational efficiency of the vehicle AI system 100 by performing parallel inference operations using multimodal sensor data, telemetry data, environmental data, route data, and prompt data processed simultaneously using distributed inference resources associated with the vehicle edge computing system 115 and the cloud orchestration system 170.

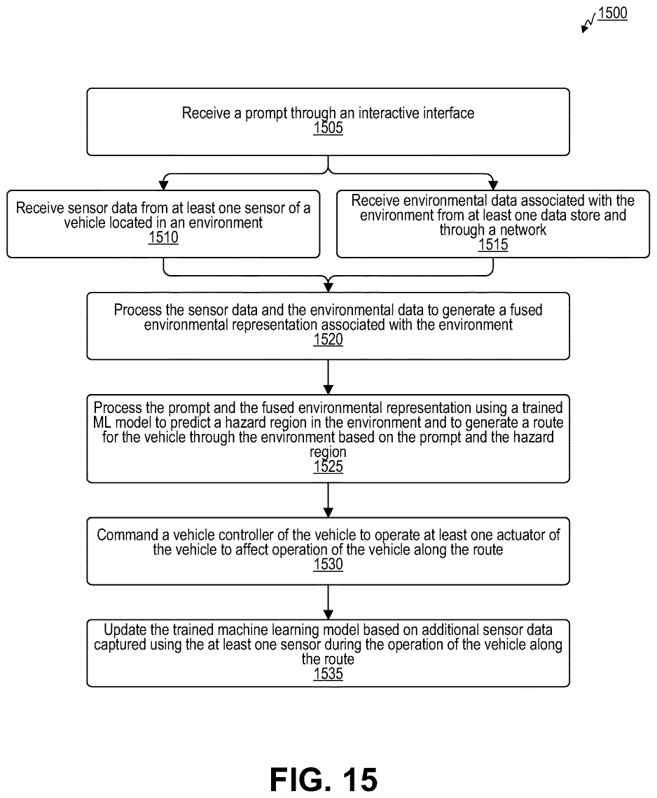

FIG. 15 is a flow diagram illustrating a process 1500 for vehicle-based artificial intelligence. In some examples, the process 1500 is performed using the vehicle AI system 100, the sensors 105, the sensor fusion engine 110, the vehicle edge computing system 115, the vehicle AI engine 120, the hazard prediction engine 125, the route prediction engine 130, the contextual response generator 135, the user device interface 140, the controller command generator 145, the vehicle controller 150, the vehicle actuators 155, the vehicle feedback interpreter 160, the machine learning update engine 165, the cloud orchestration system 170, the telemetry and model synchronization engine 180, the AI system 1400, the ML engine 1420, the ML model(s) 1425, the computing system 1600, a processor executing instructions stored on a non-transitory computer-readable storage medium and corresponding to a program, or combinations thereof. In some examples, the process 1500 is computer-implemented and performed at least in part locally using the vehicle edge computing system 115 (e.g., using local ML model inference operations), and performed at least in part remotely using the cloud orchestration system 170 (e.g., using distributed ML model inference operations). In some examples, the process 1500 improves environmental awareness, hazard prediction accuracy, route-generation accuracy, autonomous-driving responsiveness, telemetry synchronization, and/or low-latency vehicle-control operations by integrating multimodal sensor fusion, predictive machine learning operations, and adaptive vehicle-control orchestration.

At operation 1505, the vehicle AI system receives a prompt through an interactive interface. In some examples, the prompt is received through the user device interface 140 and/or one or more user interfaces illustrated in FIGS. 3-6. In some examples, the prompt includes spoken audio, typed input, touchscreen input, gesture input, navigation requests, calendar-event requests, shopping-list requests, weather requests, vehicle-operation requests, climate-control requests, and/or destination requests. In some examples, the prompt is processed using the vehicle AI engine 120, the language model 1050, and/or one or more ML model(s) 1425. In some examples, the prompt includes a request to travel to a calendar event associated with the user interfaces 310-340, a request to navigate to a destination associated with the user interface 420, a shopping-list request associated with the user interfaces 510-550, and/or a vehicle-related request associated with the user interfaces 610-640.

In some examples, operation 1505 includes receiving a voice clip recorded using one or more microphones associated with the sensors 105 and processing the voice clip using the speech-to-text model 1040 to generate (transcribe) text corresponding to the prompt. In some examples, the speech-to-text model 1040 performs contextual parsing, wake-word detection, speaker identification, and/or streaming speech recognition to improve prompt-recognition accuracy within vehicle environments.

At operation 1510, the vehicle AI system receives sensor data from at least one sensor of a vehicle located in an environment. In some examples, the at least one sensor includes the sensors 105. In some examples, the at least one sensor is coupled to the vehicle. In some examples, the at least one sensor includes one or more cameras, radar sensors, lidar sensors, positioning receivers, GNSS receivers, inertial measurement units (IMUs), microphones, wheel-speed sensors, tire-pressure sensors, battery-state sensors, environmental sensors, depth sensors, ultrasonic sensors, and/or telemetry sensors associated with the vehicle. In some examples, the sensor data includes image data, telemetry data, environmental-condition data, location-related data, depth data, occupancy data, obstacle data, vehicle-state data, route-progression data, and/or weather-related data associated with operation of the vehicle. In some examples, the sensor data is received continuously as streaming telemetry data during operation of the vehicle.

At operation 1515, the vehicle AI system receives environmental data associated with the environment from at least one data store and through a network. In some examples, the environmental data is received from the data sources 175, the network service systems 760, the data stores 755, remote network systems, map systems, weather systems, traffic systems, hazard systems, parking systems, charging systems, retail inventory systems, reservation systems, and/or cloud-based orchestration systems. In some examples, the environmental data includes weather data, traffic data, construction data, road-condition data, flooding data, map data, hazard data, inventory data, parking data, charging-station data, and/or destination-availability data associated with the environment surrounding the vehicle.

In some examples, operations 1510 and 1515 are performed asynchronously and/or at least partially in parallel using distributed processing resources associated with the vehicle edge computing system 115 and the cloud orchestration system 170. In some examples, asynchronous receipt and processing of sensor data and environmental data reduces latency associated with route generation and hazard prediction.

At operation 1520, the vehicle AI system processes the sensor data and the environmental data to generate a fused environmental representation associated with the environment. In some examples, the sensor fusion engine 110 processes the sensor data and the environmental data using sensor-fusion operations including temporal alignment, spatial alignment, normalization, object detection, object tracking, occupancy-grid generation, semantic segmentation, environmental classification, and/or trajectory prediction. In some examples, processing the sensor data and the environmental data includes performing simultaneous localization and mapping (SLAM) to generate a map associated with the environment and to identify a pose of the vehicle within the map. In some examples, the fused environmental representation includes a local environmental map, occupancy representation, route representation, semantic environmental representation, obstacle representation, hazard representation, and/or vehicle-state representation associated with the environment surrounding the vehicle.

In some examples, generating the fused environmental representation improves environmental awareness and route-generation accuracy by integrating multimodal sensor data with remote environmental data into a unified environmental model usable for hazard prediction and autonomous vehicle-control operations.

At operation 1525, the vehicle AI system processes the prompt and the fused environmental representation using a trained machine learning model to predict a hazard region in the environment and to generate a route for the vehicle through the environment based on the prompt and the hazard region. In some examples, the trained machine learning model includes one or more ML model(s) 1425 associated with the vehicle AI engine 120, the hazard prediction engine 125, and/or the route prediction engine 130. In some examples, the trained machine learning model includes a plurality of machine learning models configured to perform parallel inference operations associated with prediction of the hazard region and generation of the route. In some examples, a first machine learning model predicts the hazard region while a second machine learning model generates the route.

In some examples, the trained machine learning model performs distributed inference operations using the vehicle edge computing system 115 and the cloud orchestration system 170. In some examples, the vehicle edge computing system 115 dynamically selects between local inference and remote inference based on network conditions, computational load, latency constraints, timing constraints, confidence scores, and/or power-consumption constraints. In some examples, distributed inference operations improve responsiveness of vehicle-control operations and reduce latency associated with hazard prediction and route generation.

In some examples, the hazard region is associated with traffic, an accident, a road condition, construction, a weather condition, flooding, low traction, reduced visibility, obstacle regions, debris regions, and/or unsafe environmental conditions identified using the fused environmental representation. In some examples, the vehicle AI system generates the route to minimize passage of the vehicle through the hazard region, and/or to avoid the hazard region or prevent entry of the vehicle into the hazard region. In some examples, the vehicle AI system dynamically updates the route responsive to changing environmental conditions, updated telemetry data, changing traffic conditions, and/or newly identified hazards. The hazard region may be a single contiguous area or may include a plurality of non-contiguous areas in the environment.

In some examples, the vehicle AI system parses the prompt using the vehicle AI engine 120 and/or one or more ML model(s) 1425 to identify a destination associated with a calendar event, a shopping list-based destination, a charging station, a fueling station, a parking location, a tire pump station, a weather-aware destination, and/or another destination associated with the user interfaces of FIGS. 3-6. In some examples, the route directs the vehicle to the destination identified from the prompt. In some examples, the route includes routes to locations (e.g., stores) associated with acquisition (e.g., purchase) of items from a list (e.g., shopping list) of items identified from a list interface, such as the user interfaces 510-550. In some examples, the vehicle AI system generates the route to direct the vehicle to at least a subset of the locations (e.g., of at least a subset of the stores) based on vehicle operation history (e.g., previous routes to acquire the same items from the same stores at the same locations), inventory availability associated with the stores, and/or predicted perishability timing associated with the items.

In some examples, operation 1525 includes predicting an arrival time at the destination based on the route. In some examples, the vehicle AI system sends a reservation request associated with the destination for a reservation time based on the predicted arrival time. In some examples, the reservation request includes a restaurant reservation request, parking reservation request, charging reservation request, fueling request, service appointment request, and/or another destination-coordination request associated with the process 900. In some examples, the vehicle AI system predicts a change in the arrival time based on operation of the vehicle along the route and automatically sends a modification to the reservation request based on the predicted change in the arrival time.

At operation 1530, the vehicle AI system commands a vehicle controller of the vehicle to operate at least one actuator of the vehicle to affect operation of the vehicle along the route. In some examples, the controller command generator 145 generates a command for the vehicle controller 150 using the trained machine learning model based on one or more parameters associated with the at least one actuator and at least one component of the vehicle coupled to the at least one actuator. In some examples, the controller command generator 145 transmits the command to the vehicle controller 150 to cause the vehicle controller 150 to operate the at least one actuator of the vehicle.

In some examples, the at least one actuator includes steering actuators, braking actuators, acceleration actuators, drivetrain actuators, climate-control actuators, navigation actuators, suspension actuators, robotic actuators, and/or autonomous-driving actuators associated with the vehicle actuators 155. Commanding the vehicle controller can include proactively controlling steering, braking, acceleration, lane positioning, obstacle avoidance, parking operations, route-following operations, climate-control operations, charging operations, and/or autonomous-driving operations associated with operation of the vehicle along the route. In some examples, the vehicle AI system autonomously controls operation of the vehicle along the route. In some examples, the vehicle AI system assists with operation of the vehicle using one or more driver-assistance operations.

In some examples, while the vehicle is traveling along the route, the vehicle AI system continues to receive additional prompts, sensor data, location data, telemetry data, and/or environmental data, and proactively modifies operation of the vehicle based on the updated information. For example, the vehicle AI system can modify steering, braking, acceleration, lane-position, climate-control settings, suspension, charging, discharging, and/or route-following operations responsive to newly detected hazards, changing traffic conditions, changing weather conditions, changing road conditions, updated destination information, updated user preferences, and/or updated telemetry information received while the vehicle operates along the route.

In some examples, the vehicle AI system proactively modifies operation of the vehicle without receiving an additional prompt after operation 1505. For example, the vehicle AI system can proactively reroute the vehicle, reduce vehicle speed, increase following distance, modify lane positioning, adjust suspension settings, modify climate-control settings, identify charging locations, and/or initiate hazard-avoidance operations responsive to updated sensor data, telemetry data, environmental data, and/or hazard predictions generated while the vehicle is traveling along the route.

In some examples, the vehicle AI system predicts future environmental conditions associated with portions of the route that the vehicle has not yet reached, and proactively modifies operation of the vehicle before the vehicle reaches the corresponding portions of the route. For example, the vehicle AI system can proactively modify navigation responsive to predicted flooding, low-traction conditions, traffic congestion, construction, debris, and/or weather conditions.

In some examples, the vehicle AI system dynamically modifies vehicle-operation commands during operation of the vehicle based on inferred and/or detected driving preferences associated with a user. For example, the vehicle AI system can dynamically adjust acceleration responsiveness, braking aggressiveness, lane-position preferences, following distance, suspension behavior, route preferences, and/or climate-control behavior responsive to telemetry data, user feedback, environmental conditions, and/or updated prompts received during operation of the vehicle.

In some examples, while the vehicle travels along the route, the vehicle AI system proactively (or in response to a prompt and/or response as in user interface 620) identifies current and/or predicted charging conditions, fueling conditions, battery conditions, and/or vehicle-range conditions, and proactively modifies the route to include charging stations, fueling stations, maintenance locations, and/or stopping locations before the vehicle's charge level or fuel level fall below corresponding thresholds.

In some examples, the vehicle AI system 100 compares telemetry values, environmental-condition values, hazard scores, route-safety scores, confidence scores, fuel levels, predicted fuel levels, battery-charge levels, predicted battery-charge levels, temperature values, tire-pressure values, and/or vehicle-health values against one or more thresholds during operation of the vehicle. Reaching or crossing such thresholds can cause the vehicle AI system to proactively modify commands for vehicle operation, route-generation, charging, fueling, climate-control, suspension, and/or autonomous driving.

In some examples, operation 1530 includes generating a response associated with operation of the vehicle along the route and outputting the response through the interactive interface. In some examples, the response is generated using the contextual response generator 135 and/or one or more ML model(s) 1425. In some examples, the response is generated based on the sensor data, the route, the hazard region, telemetry data, vehicle-operation data, and/or operation of the vehicle controller 150. In some examples, the response identifies the hazard region, route modifications, weather conditions, navigation operations, and/or actions performed by the vehicle. In some examples, the response is output as displayed text, synthesized speech, graphical content, route summaries, notifications, and/or contextual conversational responses associated with the user interfaces of FIGS. 3-6.

In some examples, operation 1530 includes processing the response using the text-to-speech model 1045 to generate a synthesized voice clip indicative of the response and playing the synthesized voice clip using one or more speakers associated with the vehicle. In some examples, synthesized speech improves user awareness of vehicle operations without requiring continuous visual interaction with a display.

In some examples, operation 1530 includes authenticating a user based on a first factor of authentication associated with a signup and/or sign-in system 1005 to the identity provider 1010, a second factor of authentication associated with the authentication token 1015, and a third factor of authentication associated with vehicle hardware associated with the vehicle authentication system 1075. In some examples, the vehicle hardware includes a vehicle key, key fob, secure hardware module, telematics module, near field communication (NFC) device, Bluetooth low energy (BLE) device, ultra wideband (UWB) device, and/or another vehicle-linked authentication element associated with the vehicle authentication system 1075. Such multi-factor authentication improves security associated with remote vehicle control operations, telemetry access, and autonomous driving.

At operation 1535, the vehicle AI system updates the trained machine learning model based on additional sensor data captured using the at least one sensor during operation of the vehicle along the route. In some examples, the machine learning update engine 165 updates one or more numeric weights associated with the trained machine learning model based on route feedback associated with operation of the vehicle along the route. In some examples, the one or more numeric weights are used to generate the route. In some examples, operation 1535 includes reinforcement learning, continual learning, online learning, retraining, fine-tuning, checkpoint updating, backpropagation, and/or model synchronization operations associated with the AI system 1400.

In some examples, operation 1535 includes receiving feedback associated with operation of the vehicle through the interactive interface. In some examples, the feedback includes route feedback, hazard feedback, climate-control feedback, satisfaction feedback, destination feedback, driving-style feedback, and/or navigation feedback associated with operation of the vehicle. In some examples, the trained machine learning model is updated based on the feedback to improve future route-generation operations, hazard-prediction operations, destination-coordination operations, and/or vehicle-control operations.

In some examples, operation 1535 includes synchronizing updated machine learning model state information between the vehicle edge computing system 115 and the cloud orchestration system 170 using the telemetry and model synchronization engine 180. In some examples, synchronization operations are performed asynchronously using distributed messaging systems, event streams, and/or publish-subscribe architectures.

In some examples, the vehicle AI system interfaces with one or more account-management systems to create, validate, update, synchronize, and/or remove user accounts, vehicle-linked accounts, subaccounts, household accounts, subscription accounts, and/or shared-access accounts associated with operation of the vehicle AI system 100. In some examples, the vehicle AI system synchronizes account information among the mobile vehicle app 705, the cloud orchestration system 170, the data stores 755, and/or one or more vehicle systems 1070 using asynchronous synchronization operations.

In some examples, the vehicle AI system dynamically manages permissions associated with vehicle operations, telemetry access, sensor access, location access, calendar access, messaging access, shopping-list access, reservation access, and/or autonomous-driving operations. In some examples, the vehicle AI system selectively grants or restricts access to vehicle functions based on authentication state, user role, subscription state, vehicle proximity, authorization policies, and/or detected user behavior.

In some examples, the vehicle AI system interfaces with one or more payment-processing systems, subscription-management systems, and/or transaction systems to manage subscription plans, reservation payments, charging payments, fueling payments, toll payments, parking payments, retail purchases, and/or other transactions associated with operation of the vehicle AI system. In some examples, the vehicle AI system performs secure payment-processing operations using encrypted communication channels, authentication tokens, and/or isolated payment-processing subsystems.

In some examples, the vehicle AI system generates and maintains user-specific behavioral models, intent models, preference models, and/or persona models associated with one or more users. In some examples, the vehicle AI system predicts user preferences associated with driving style, destination selection, shopping behavior, climate-control preferences, calendar usage, and/or route-selection behavior based on historical interactions, telemetry data, environmental conditions, and/or prior vehicle operations. The vehicle AI system can dynamically customize generated routes, responses, notifications, and/or vehicle-control operations based on the predicted user preferences.

In some examples, the vehicle AI system interfaces with one or more external tools, APIs, messaging systems, calendar systems, navigation systems, retail systems, weather systems, charging systems, parking systems, and/or reservation systems using one or more tool commands 1455 and/or retrieval operations associated with the AI system 1400. The vehicle AI system can use RAG operations to retrieve contextual information associated with destinations, inventory availability, environmental conditions, and/or vehicle operations prior to generating routes, commands, and/or contextual responses.

In some examples, the vehicle AI system continuously monitors environmental conditions associated with current and future route segments and proactively generates hazard notifications, rerouting operations, route-modification commands, and/or vehicle-operation modifications responsive to predicted weather conditions, traffic conditions, road conditions, flooding conditions, construction conditions, and/or obstacle conditions. In some examples, the vehicle AI system 100 predicts environmental changes before the vehicle reaches affected route segments and proactively modifies operation of the vehicle to reduce safety risks and improve operational efficiency.

In some examples, the vehicle AI system processes multimodal sensor data generated by vehicles, mobile devices, unmanned ground vehicles (UGVs), unmanned aerial vehicles (UAVs), wearable devices, and/or remote sensing systems. In some examples, the vehicle AI system uses SLAM, VSLAM, occupancy-grid generation, semantic segmentation, object detection, and/or trajectory-prediction operations to generate environmental representations associated with operation of autonomous and semi-autonomous vehicle systems.

In some examples, the vehicle AI system dynamically selects among a plurality of machine learning models based on latency constraints, network conditions, confidence scores, compute-resource availability, vehicle state, environmental complexity, and/or operational context. In some examples, the vehicle AI system 100 performs parallel inference operations using multiple specialized machine learning models associated with speech recognition, route prediction, hazard prediction, environmental classification, contextual response generation, and/or autonomous-driving operations to reduce inference latency and improve responsiveness of vehicle-control operations.

In some examples, the process 1500 improves operation of the vehicle AI system 100 by dynamically integrating prompt processing, multimodal sensor fusion, hazard prediction, distributed machine learning inference, adaptive route generation, telemetry synchronization, and autonomous vehicle-control operations within a unified machine-learning architecture. In some examples, the process 1500 improves environmental awareness, reduces latency associated with route-generation operations, improves hazard-avoidance accuracy, improves synchronization between vehicle systems and cloud systems, reduces unsafe route traversal, improves autonomous-driving responsiveness, improves destination-coordination accuracy, and improves machine-learning adaptation based on real-world vehicle telemetry feedback.

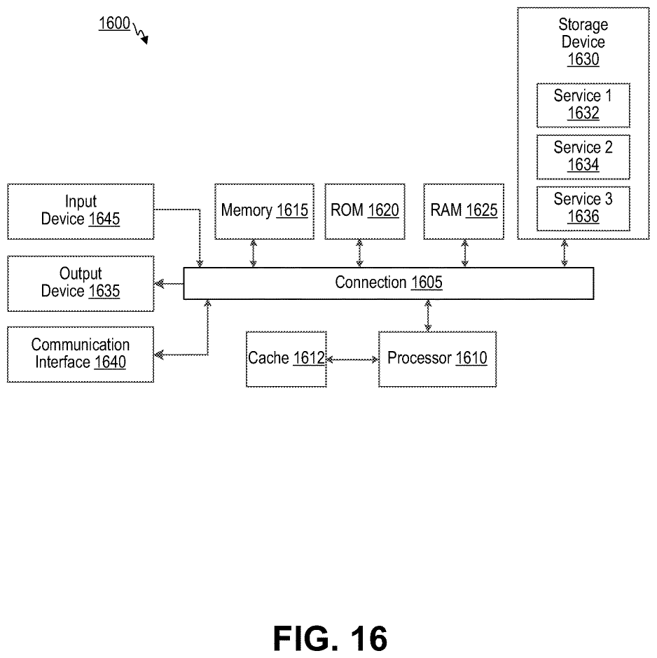

FIG. 16 is a diagram illustrating an example of a system for implementing certain components of the present technology. In particular, FIG. 16 illustrates an example of computing system 1600, which can be, for example, any computing device making up an internal computing system, a remote computing system, a camera, or any component thereof in which the components of the system are in communication with each other using connection 1605. Connection 1605 can be a physical connection using a bus, or a direct connection into processor 1610, such as in a chipset architecture. Connection 1605 can also be a virtual connection, networked connection, or logical connection.

The computing system 1600 can be a distributed system in which the functions described in this disclosure can be distributed within one or more data centers or a peer network. The described system components can represent multiple instances of such components, each performing some or all of the function for which the component is described. The computing system 1600 can include physical devices and/or virtual devices.

In some examples, the computing system 1600 implements at least a portion of the AI system 1400. For instance, the processor 1610 can execute instructions stored in the system memory 1615 and/or storage device 1630 to implement the ML engine 1420, ML model(s) 1425, feedback engine(s) 1460, tool(s) 1485, and/or other component(s) of the AI system 1400. The storage device 1630 and/or system memory 1615 can store model weights, parameters, hyperparameters, prompts, embeddings, vector indexes, training data 1475, data store(s) 1480, checkpoint(s), feedback record(s), tool schema(s), tool command history, and/or software instructions for inference, training, fine-tuning, retrieval, tool-command generation, tool invocation, feedback processing, and/or model updating.

In some examples, the AI system 1400 is distributed across multiple computing system(s) 1600, such that different computing systems host or execute the ML engine 1420, ML model(s) 1425, feedback engine(s) 1460, data store(s) 1480, and/or tool(s) 1485. The communications interface 1640 can transmit and receive input(s) 1405, output(s) 1430, tool command(s) 1455, feedback 1465, training data 1475, and/or other data among such computing systems. The cache 1612, RAM 1625, accelerator memory, and/or other high-speed memory can store active model weights, activations, retrieved context, tool responses, and/or batch data while the processor 1610 and/or accelerator(s) perform operations of the AI system 1400.

The computing system 1600 can include at least one processor 1610 and connection 1605 that couples system memory 1615, such as read-only memory (ROM 1620) and random access memory (RAM 1625), to the processor 1610. The computing system 1600 can include a cache 1612 of high-speed memory connected directly with, in close proximity to, or integrated as part of processor 1610 (e.g., registers, on-chip memory).

Processor 1610 can include a processor paired with a hardware service or software service, such as services 1632, 1634, and 1636 stored in storage device 1630, configured to control processor 1610, and/or a special-purpose processor where instructions are incorporated into the actual processor design. Processor 1610 may be a self-contained computing system, including multiple cores or processors, a bus, memory controller, and/or cache. A multi-core processor may be symmetric or asymmetric.

To provide for user interaction, computing system 1600 includes an input device 1645, which can represent any number of input mechanisms, such as a microphone for speech, a touch-sensitive screen for gesture or graphical input, a keyboard, a mouse, and/or a motion detection sensor. Computing system 1600 can also include output device 1635, which can include a display, a speaker, and/or a haptic feedback actuator. Multimodal systems can allow for provision of multiple types of input/output to communicate with computing system 1600. Computing system 1600 can include communications interface 1640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Ethernet port/plug, a fiber optic port/plug, a proprietary wired port/plug, a BLUETOOTH® wireless signal transfer, a BLUETOOTH® low energy (BLE) wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), infrared (IR) communication wireless signal transfer, Public Switched Telephone Network (PSTN) signal transfer, Integrated Services Digital Network (ISDN) signal transfer, 3G/4G/LTE/5G/6G cellular data network wireless signal transfer, ad-hoc network signal transfer, radio wave signal transfer, microwave signal transfer, infrared signal transfer, visible light signal transfer, ultraviolet light signal transfer, and/or wireless signal transfer along the electromagnetic spectrum. The communications interface 1640 may include Global Navigation Satellite System (GNSS) receiver(s) or transceiver(s) that are used to determine a location of the computing system 1600 based on receipt of signal(s) from satellite(s) associated with GNSS system(s), such as the Global Positioning System (GPS), the Global Navigation Satellite System (GLONASS), the BeiDou Navigation Satellite System (BDS), and Galileo.

The storage device 1630 can include instructions (e.g., code) defining software services, servers, model runtime services, inference services, retrieval services, tool interface services, feedback services, update services, and/or other services executable by the processor 1610 to cause the system to perform a function. In some examples, a hardware service that performs a particular function can include code stored in a computer-readable medium in connection with the processor 1610, connection 1605, and/or output device 1635.

What is claimed is:

1. A computer-implemented method for vehicle-based artificial intelligence, the computer-implemented method comprising:
receiving a prompt through an interactive interface;
receiving sensor data from at least one sensor of a vehicle located in an environment;
receiving environmental data associated with the environment from at least one data store and through a network;
processing the sensor data and the environmental data to generate a fused environmental representation associated with the environment;
processing the prompt and the fused environmental representation using a trained machine learning model to predict a hazard region in the environment and to generate a route for the vehicle through the environment based on the prompt and the hazard region;
commanding a vehicle controller of the vehicle to operate at least one actuator of the vehicle to affect operation of the vehicle along the route; and
updating the trained machine learning model based on additional sensor data captured using the at least one sensor during the operation of the vehicle along the route.

2. The computer-implemented method of claim 1, further comprising:
generating a response associated with the operation of the vehicle along the route; and
outputting the response through the interactive interface.

3. The method of claim 2, further comprising:
processing the response using a speech synthesis model to generate a synthesized voice clip indicative of the response; and
playing the synthesized voice clip using a speaker associated with the vehicle.

4. The computer-implemented method of claim 1, further comprising:
receiving feedback associated with the operation of the vehicle along the route through the interactive interface, wherein updating the trained machine learning model based on the feedback to modify at least one further operation of the vehicle.

5. The computer-implemented method of claim 1, wherein processing the sensor data and the environmental data to generate the fused environmental representation includes processing the sensor data and the environmental data using simultaneous localization and mapping (SLAM) to generate a map of the environment and to identify a pose of the vehicle within the map.

6. The computer-implemented method of claim 1, further comprising:
selecting the trained machine learning model from a plurality of trained machine learning models based on network conditions and computational load, wherein the plurality of trained machine learning models includes a local trained machine learning model and a remote trained machine learning model.

7. The computer-implemented method of claim 1, wherein the route is generated to minimize passage of the vehicle through the hazard region.

8. The computer-implemented method of claim 1, wherein the hazard region is associated with at least one of traffic, an accident, a road condition, construction, or a weather condition.

9. The computer-implemented method of claim 1, wherein commanding the vehicle controller includes:
generating a command for the vehicle controller using the trained machine learning model based on one or more parameters associated with the at least one actuator and at least one component of the vehicle coupled to the at least one actuator; and
transmitting the command to the vehicle controller to cause the vehicle controller to operate the at least one actuator of the vehicle to affect the at least one component of the vehicle.

10. The computer-implemented method of claim 1, wherein commanding the vehicle controller to operate the at least one actuator to affect the operation of the vehicle along the route includes proactively controlling at least one of steering, braking, or acceleration of the vehicle.

11. The computer-implemented method of claim 1, wherein commanding the vehicle controller to operate the at least one actuator to affect the operation of the vehicle along the route includes assisting with at least one of lane positioning, obstacle avoidance, or parking.

12. The computer-implemented method of claim 1, further comprising:
receiving a voice clip recorded using a microphone; and
transcribing the voice clip to generate text, wherein the text includes the prompt.

13. The computer-implemented method of claim 1, further comprising:
authenticating a user of the vehicle based on a first factor of authentication associated with a sign-in to an identity provider system, a second factor of authentication associated with an authentication token received through the identity provider system, and a third factor of authentication associated with vehicle hardware associated with the vehicle.

14. The computer-implemented method of claim 13, wherein the vehicle hardware includes at least one of a key to the vehicle or a key fob corresponding to the vehicle.

15. The computer-implemented method of claim 1, further comprising:
parsing the prompt to identify a destination, wherein the route directs the vehicle to the destination;
predicting an arrival time at the destination based on the route; and
sending a reservation request associated with the destination for a reservation time that is based on the arrival time;
predicting a change in the arrival time at the destination based on the operation of the vehicle along the route; and
sending a modification to the reservation request based on the change in the arrival time.

16. The computer-implemented method of claim 1, further comprising:
parsing a list to identify a plurality of items;
identifying a plurality of locations associated with acquisition of the plurality of items based on vehicle operation history, wherein the route includes at least a subset of the plurality of locations.

17. The computer-implemented method of claim 1, wherein updating the trained machine learning model includes updating one or more numeric weights of the trained machine learning model based on route feedback associated with operation of the vehicle along the route, the one or more numeric weights used to generate the route.

18. The computer-implemented method of claim 1, wherein the at least one sensor is coupled to the vehicle.

19. A system of vehicle-based artificial intelligence, the system comprising:
a memory that stores instructions; and
a processor coupled to the memory, wherein execution of the instructions by the processor causes the processor to:
receive a prompt through an interactive interface;
receive sensor data from at least one sensor of a vehicle located in an environment;
receive environmental data associated with the environment from at least one data store and through a network;
process the sensor data and the environmental data to generate a fused environmental representation associated with the environment;
process the prompt and the fused environmental representation using a trained machine learning model to predict a hazard region in the environment and to generate a route for the vehicle through the environment based on the prompt and the hazard region;
command a vehicle controller of the vehicle to operate at least one actuator of the vehicle to affect operation of the vehicle along the route; and
update the trained machine learning model based on additional sensor data captured using the at least one sensor during the operation of the vehicle along the route.

20. A non-transitory computer readable storage medium having embodied thereon a program, wherein the program is executable by a processor to perform a method of vehicle-based artificial intelligence, the method comprising:
receiving a prompt through an interactive interface;
receiving sensor data from at least one sensor of a vehicle located in an environment;
receiving environmental data associated with the environment from at least one data store and through a network;
processing the sensor data and the environmental data to generate a fused environmental representation associated with the environment;
processing the prompt and the fused environmental representation using a trained machine learning model to predict a hazard region in the environment and to generate a route for the vehicle through the environment based on the prompt and the hazard region;
commanding a vehicle controller of the vehicle to operate at least one actuator of the vehicle to affect operation of the vehicle along the route; and
updating the trained machine learning model based on additional sensor data captured using the at least one sensor during the operation of the vehicle along the route.
